(19) United States
(12) Patent Application Publication
(10) Pub. No.: US 2013/0173169 A1
(43) Pub. Date: Jul. 4, 2013

(54) METHOD AND SYSTEM FOR EFFICIENT WAVELENGTH EXTRAPOLATION

(71) Applicant: Naide Pan, Sugarland, TX (US)

(72) Inventor: Naide Pan, Sugarland, TX (US)

(73) Assignee: PGS Geophysical AS, Lysaker (NO)

(21) Appl. No.: 13/341,973

(22) Filed: Dec. 31, 2011

(51) Int. Cl. G06F 19/00; G01V 1/30

(52) U.S. Cl. 702/17; 702/14

(57) ABSTRACT

The current application is directed to computational systems and methods carried out by the computational systems for characterizing and/or imaging subsurface features based on digitally encoded data collected during exploration-seismology experiments. In particular, the current application is directed to computationally efficient methods and systems for processing data collected across a two-dimensional surface to produce, by stepwise propagation, a digitally encoded, stored-data representation of a three-dimensional pressure wavefield that is used in many different applications. In certain applications, the stored-data representation of a three-dimensional pressure wavefield is used, along with initial values and a portion of the boundary conditions, to solve for unknown portions of boundary conditions, including the structures and distributions of subsurface features and materials.

### BACKGROUND

The field of exploration seismology has emerged over the course of the past 130 years, and is therefore a relatively new and developing field of science and technology. Exploration seismology seeks to characterize the structure and distribution of materials below the earth's surface by processing seismic waves transmitted into the subsurface and reflected back from subsurface features. Imaging of subsurface features by analysis of seismic waves involves collecting relatively vast amounts of data that sample a time-dependent pressure wavefield and applying computational methods to solve for initially unknown boundary conditions that, together with the acoustic and/or elastic partial-differential wave equations and initial values, specify the time-dependent pressure wavefield.

Exploration seismology has progressed during the course of the past 130 years, from initially simple and crude techniques for imaging subsurface features based on elapsed times between source impulses and reception of seismic-wave responses to the source impulses, to currently practiced computationally complex solutions to inverse boundary-condition problems with respect to second-order partial-differential wave equations based on instrumental sampling of seismic wavefields. Despite a steady increase in the computational processing power and the electronic data-storage capacities of modern computer systems, exploration-seismology analysis has continued to be constrained by processing and data-storage costs and by the bandwidths and capacities of modern computer systems, even when advanced distributed supercomputer systems are employed. As a result, researchers, developers, and practitioners of exploration-seismology-related analytical methods continue to seek computationally efficient approaches to processing of the vast amounts of digitally encoded data collected during exploration-seismology experiments which can, in turn, facilitate more cost-effective use of experimental equipment and more accurate subsurface-feature characterizations.

### BRIEF DESCRIPTION OF THE DRAWINGS

FIG. 1 illustrates a domain volume of the earth's surface.

FIG. 2 illustrates subsurface features in the lower portion of the domain volume illustrated in FIG. 1.

FIGS. 3A-C illustrate an exploration-seismology method by which digitally encoded data is instrumentally acquired for subsequent exploration-seismology processing and analysis in order to characterize the structures and distributions of features and materials underlying the solid surface of the earth.

FIGS. 4A-B illustrate processed waveforms generated from hydrophone and geophone outputs.

FIGS. 5A-D illustrate three-dimensional pressure-wavefield extrapolation.

FIG. 6A illustrates solving a normal partial-differential equation boundary-condition problem.

FIG. 6B illustrates solving an inverse boundary-condition problem.

FIG. 7 illustrates two different representations of an acoustic wavefield.

FIGS. 8A-B illustrate a wavefield-extrapolation method to which the present application is directed.

FIG. 9 shows one illustrative example of a generalized computer system that executes an efficient two-way wavefield extrapolation and therefore represents a seismic-analysis data-processing system to which the current application is directed.

### DETAILED DESCRIPTION

The current application is directed to computational systems and methods carried out by the computational systems for characterizing and/or imaging subsurface features based on digitally encoded data collected during exploration-seismology experiments. In particular, the current application is directed to computationally efficient methods and systems for processing data collected across a surface to produce, by stepwise propagation, a digitally encoded, stored-data representation of a corresponding pressure wavefield within a three-dimensional volume that includes the surface. The three-dimensional pressure wavefield is used, along with initial values and a portion of the boundary conditions, to solve for unknown portions of boundary conditions, including the structures and distributions of subsurface features and materials. The methods and systems, to which the current application is directed, employ a digitally encoded first complex virtual wavefield, constructed from a first discrete sampling of a two-dimensional slice of the three-dimensional wavefield and stored in one or more tangible, physical data-storage devices, that is transformed to a corresponding second complex virtual wavefield, by discrete computational operations, to enable extraction of a second sampling of a second two-dimensional slice of the three-dimensional wavefield from the corresponding complex virtual wavefield.

The following discussion includes three subsections: (1) an overview of exploration seismology; (2) an example acoustic-wave solution method; and (3) a discussion of a wavefield-extrapolation computational processing method as an example of computational processing methods and systems to which the current application is directed. The first and second subsections can be omitted by those familiar with exploration seismology and acoustic-wave-equation solution methods.

### An Overview of Exploration Seismology

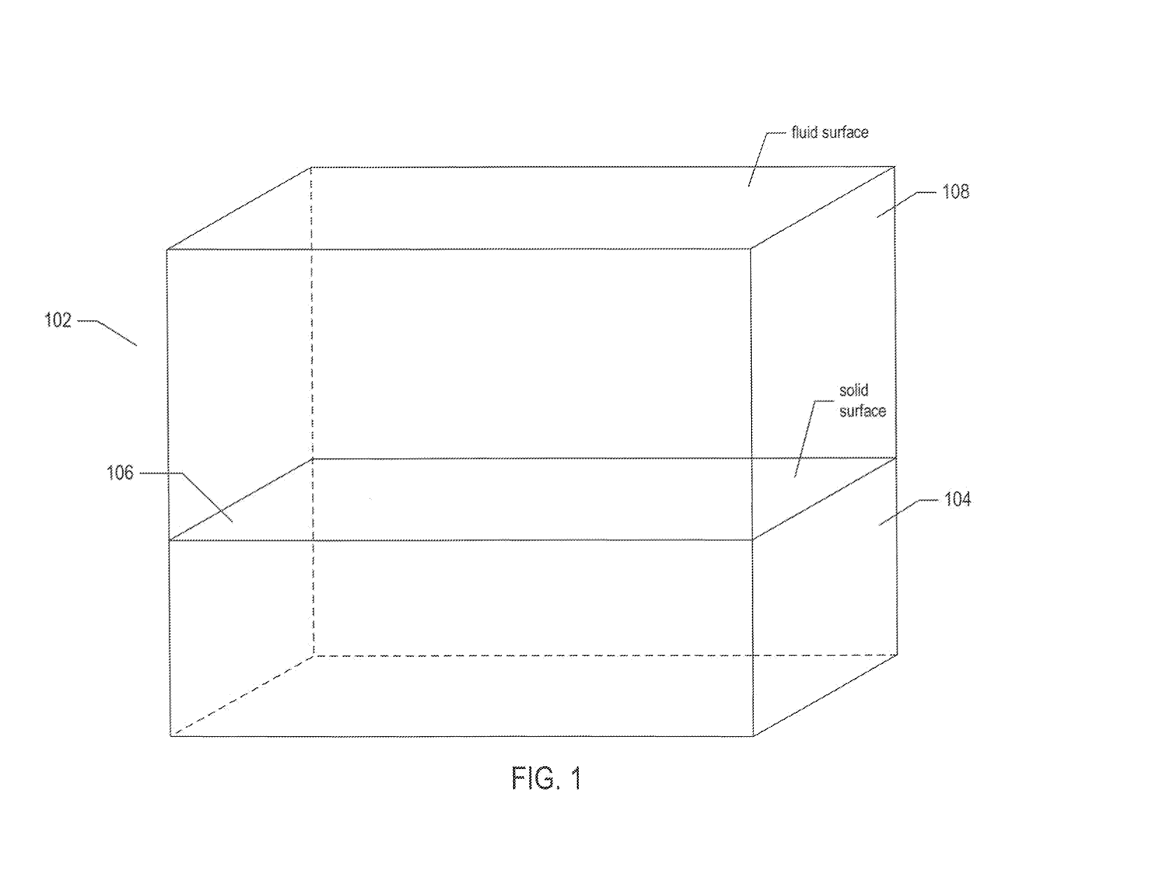

FIG. 1 illustrates a domain volume of the earth's surface. The domain volume 102 comprises a solid volume of sediment and rock 104 below the solid surface 106 of the earth that, in turn, underlies a fluid volume of water 108 within the ocean, an inlet or bay, or a large freshwater lake. The domain volume shown in FIG. 1 represents an example experimental domain for a class of exploration-seismology observational and analytical techniques and systems referred to as “marine exploration seismology.”

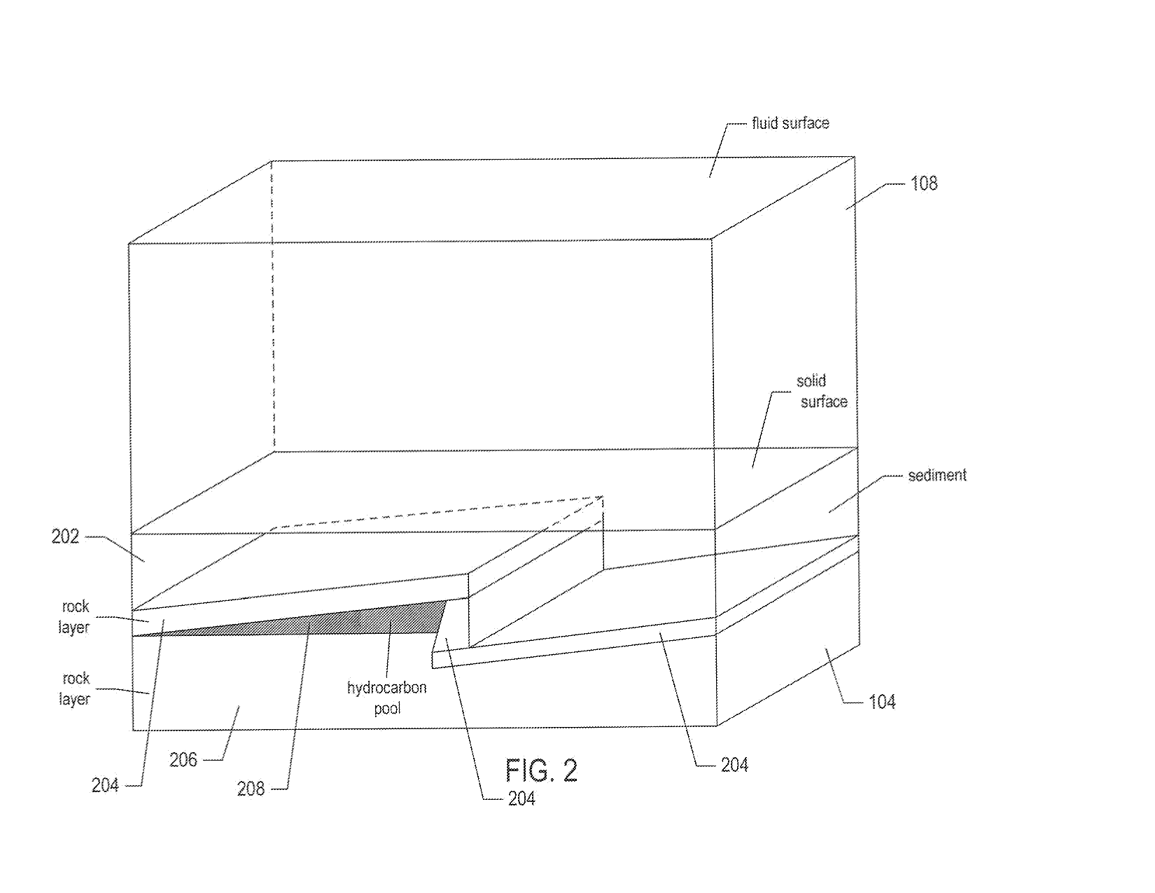

FIG. 2 illustrates subsurface features in the lower portion of the domain volume illustrated in FIG. 1. As shown in FIG. 2, for exploration-seismology purposes, the fluid volume 108 is a relatively featureless, generally homogeneous volume overlying the solid volume 104 of interest. However, while the fluid volume can be explored, analyzed, and characterized with relative precision using many different types of methods and probes; including remote-sensing submersibles, sonar, and other such devices and methods, the volume of solid crust 104 underlying the fluid volume is comparatively far more difficult to probe and characterize. Unlike the overlying fluid volume, the solid volume is significantly heterogeneous and anisotropic, and includes many different types of features and materials of interest to exploration seismologists. For example, as shown in FIG. 2, the solid volume 104 may include a first sediment layer 202, a first fractured and uplifted rock layer 204, and a second, underlying rock layer 206 below the first rock layer. In certain cases, the second rock layer 206 may be porous and contain a significant concentration of liquid hydrocarbon 208 that is less dense than the second-rock-layer material and that therefore rises upward within the second rock layer. In the case shown in FIG. 2, the first rock layer is not porous, and therefore forms a lid that prevents further upward migration of the liquid hydrocarbon, which therefore pools in a hydrocarbon-saturated layer 208 below the first rock layer 204. One goal of exploration seismology is to identify the locations of hydrocarbon-saturated porous strata within volumes of the earth's crust underlying the solid surface of the earth.

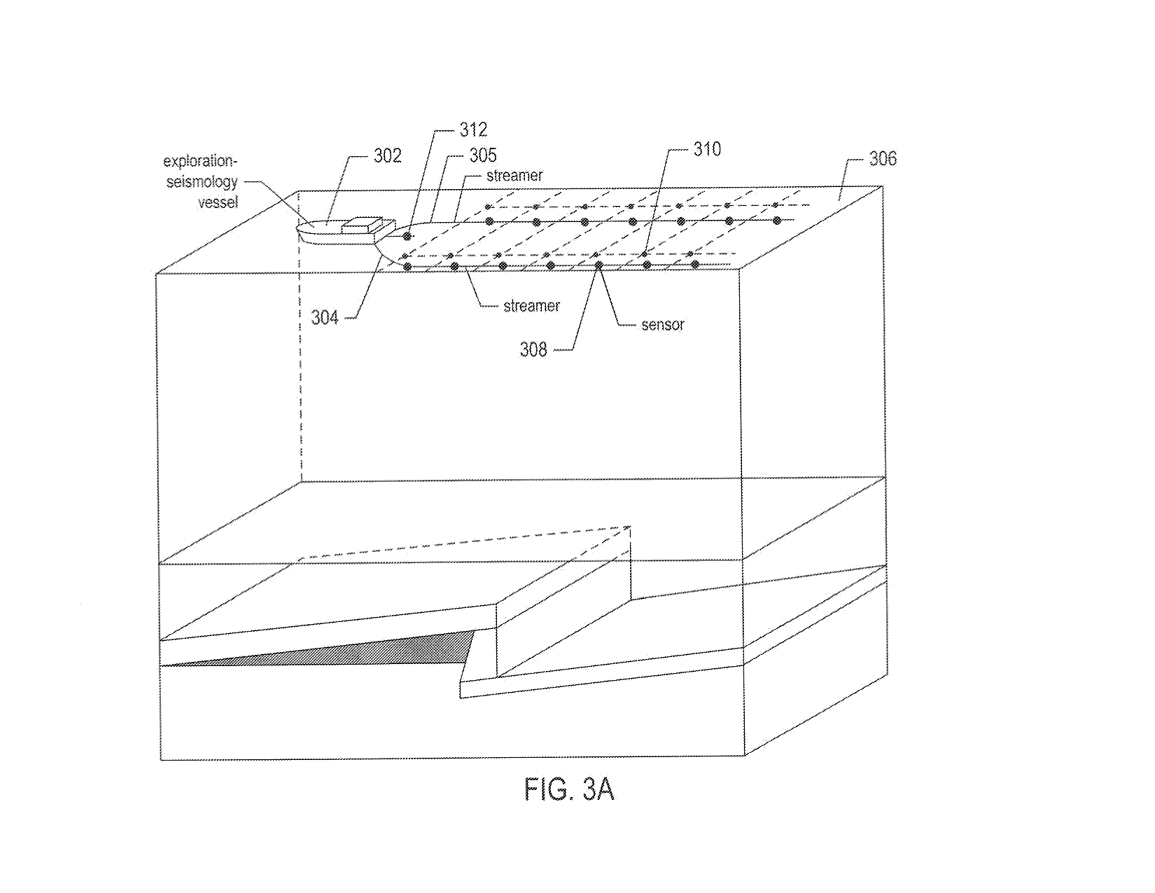

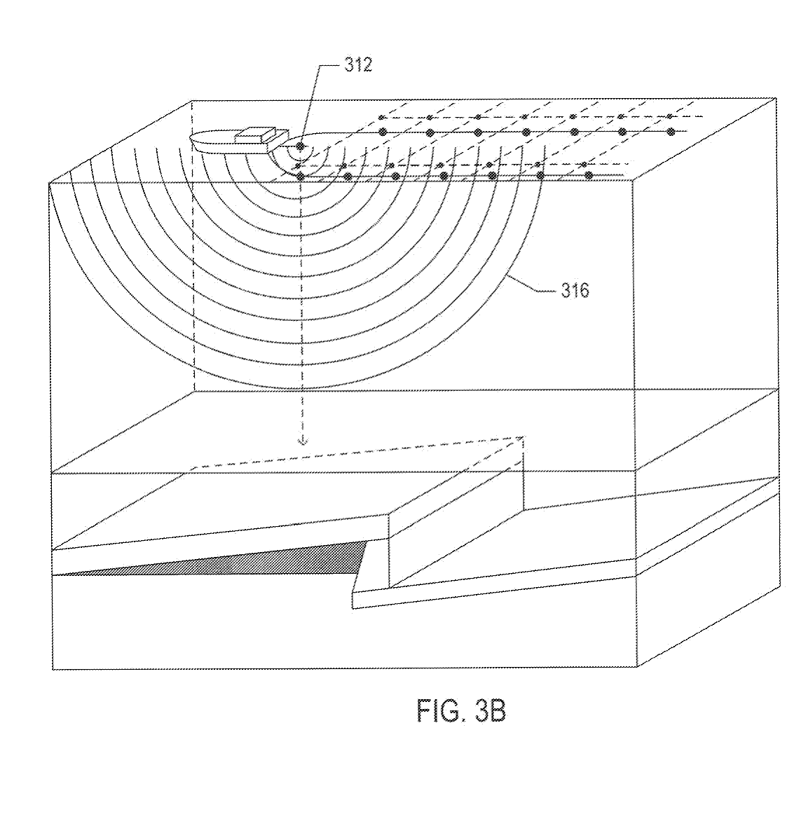

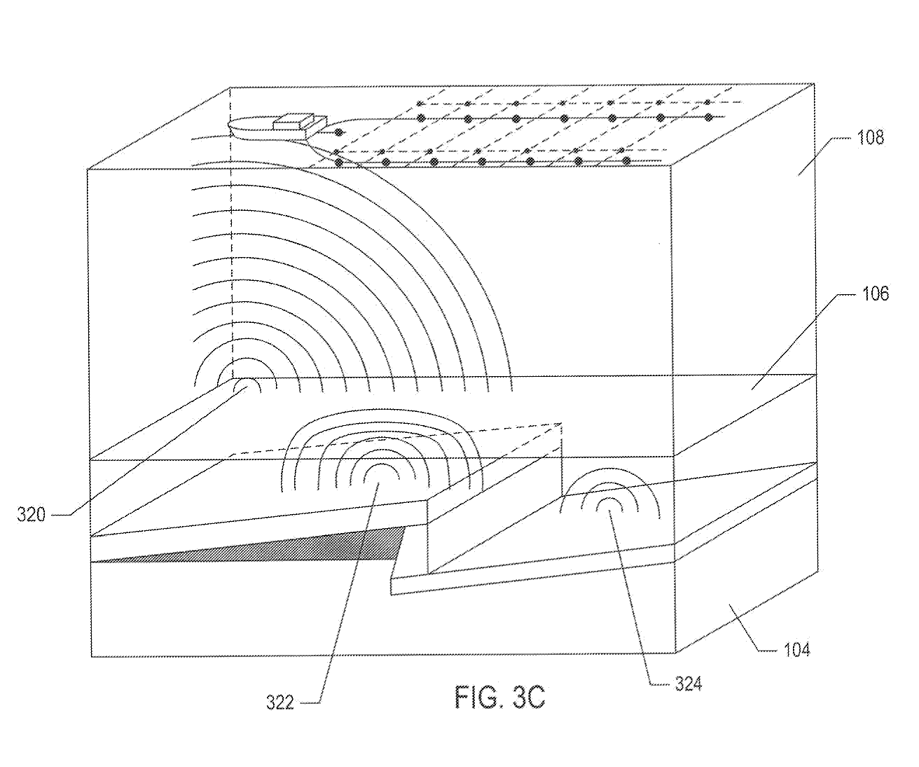

FIGS. 3A-C illustrate an exploration-seismology method by which digitally encoded data is instrumentally acquired for subsequent exploration-seismology processing and analysis in order to characterize the structures and distributions of features and materials underlying the solid surface of the earth. As shown in FIG. 3A, an exploration-seismology vessel 302 is configured to carry out a continuous series of exploration-seismology experiments and data collections. The exploration-seismology vessel 302 tows one or more streamers 304-305 across an approximately constant-depth plane generally located between five meters and a few tens of meters below the fluid surface 306. The streamers are long cables containing power and data-transmission lines to which sensors, such as the sensor represented by the shaded disk 308 in FIG. 3A, are connected at regular intervals. In one type of exploration seismology, each sensor, such as sensor 308 in FIG. 3A, comprises a pair of seismic sensors including a geophone, which detects vertical displacement within the fluid medium over time by detecting particle velocities or accelerations, and a hydrophone, which detects variations in pressure over time. The streamers and exploration-seismology vessel include sophisticated sensing electronics and data-processing facilities that allow sensor readings to be correlated with absolute positions on the fluid surface and absolute three-dimensional positions with respect to an arbitrary three-dimensional coordinate system. In FIG. 3A, the sensors along the streamers are shown to lie below the fluid surface, with the sensor positions correlated with overlying surface positions, such as surface position 310 correlated with the position of sensor 308. The exploration-seismology vessel 302 also tows one or more acoustic-wave sources 312 that produce pressure impulses at regular spatial and temporal intervals as the exploration-seismology vessel 302 and towed streamers 304-305 move forward across the fluid surface 306.

FIG. 3B illustrates an expanding, spherical acoustic wavefront, represented by semicircles of increasing radius centered at the acoustic source 312, such as semicircle 316, following an acoustic pulse emitted by the acoustic source 312. The wavefronts are, in effect, shown in vertical cross section in FIG. 3B. As shown in FIG. 3C, the outward and downward expanding acoustic wavefield, shown in FIG. 3B, eventually reaches the solid surface 106, at which point the outward and downward expanding acoustic waves partially reflect from the solid surface and partially refract downward into the solid volume, becoming elastic waves within the solid volume. In other words, in the fluid volume, the waves are compressional pressure waves, or P-waves, propagation of which can be modeled by the acoustic-wave equation, while, in a solid volume, the waves include both P-waves and transverse S-waves, the propagation of which can be modeled by the elastic-wave equation. Within the solid volume, at each interface between different types of materials or at discontinuities in density or in one or more of various other physical characteristics or parameters, downward propagating waves are partially reflected and partially refracted, as at solid surface 106. As a result, each point of the solid surface and within the underlying solid volume 104 becomes a potential secondary point source from which acoustic and elastic waves, respectively, may emanate upward toward sensors in response to the pressure impulse emitted by the acoustic source 312 and downward-propagating elastic waves generated from the pressure impulse.

As shown in FIG. 3C, secondary waves of significant amplitude are generally emitted from points on or close to the solid surface 106, such as point 320, and from points on or very close to a discontinuity in the solid volume, such as points 322 and 324. Tertiary waves may be emitted from the fluid surface back towards the solid surface in response to secondary waves emitted from the solid surface and subsurface features. In many exploration-seismology analyses, the complicated wavefield formed by the superpositions of all of the secondary, tertiary, and higher-order waves emitted in response to the initial acoustic wave, both in the fluid medium and the solid medium, are modeled as acoustic waves as an often reasonable approximation to the more accurate, but far more mathematically and computationally complicated acoustic-wave-and-elastic-wave superposition model.

FIG. 3C also illustrates the fact that secondary waves are generally emitted at different times within a range of times following the initial pressure impulse. A point on the solid surface, such as point 320, receives a pressure disturbance corresponding to the initial pressure impulse more quickly than a point within the solid volume, such as points 322 and 324. Similarly, a point on the solid surface directly underlying the acoustic source receives the pressure impulse sooner than a more distant-lying point on the solid surface. Thus, the times at which secondary and higher-order waves are emitted from various points within the solid volume are related to the distance, in three-dimensional space, of the points from the acoustic source.

Acoustic and elastic waves, however, travel at different velocities within different materials as well as within the same material under different pressures. Therefore, the travel times of the initial pressure impulse and secondary waves emitted in response to the initial pressure impulse are complex functions of distance from the acoustic source as well as the materials and physical characteristics of the materials through which the acoustic wave corresponding to the initial pressure impulse travels. In addition, as shown in FIG. 3C for the secondary wave emitted from point 322, the shapes of the expanding wavefronts may be altered as the wavefronts cross interfaces and as the velocity of sound varies in the media traversed by the wave. The superposition waves emitted from within the domain volume 102 in response to the initial pressure impulse is a generally very complicated wavefield that includes information about the shapes, sizes, and material characteristics of the domain volume 102, including information about the shapes, sizes, and locations of the various reflecting features within the solid volume of interest to exploration seismologists.

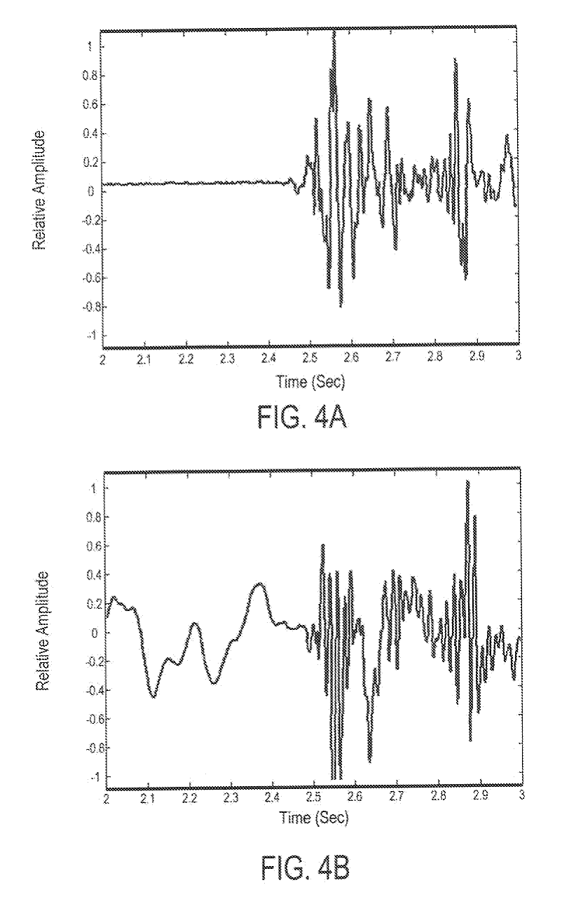

The complicated wavefield that ensues in response to the initial pressure impulse is sampled, over time, by sensors positioned along the streamers towed by the exploration-seismology vessel. FIGS. 4A-13 illustrate processed waveforms generated from hydrophone and geophone outputs. As shown in FIG. 4A, the waveform recorded by the hydrophone represents the pressure at times following the initial pressure impulse, with the amplitude of the waveform at a point in time related to the pressure at the hydrophone at the point in time. Similarly, as shown in FIG. 4B, the geophone provides an indication of the fluid velocity or acceleration, in a vertical direction, with respect to time.

Because the exploration-seismology vessel is continuously moving, the initial, processed hydrophone and geophone data is first correlated with absolute position and corrected for various characteristics of the instrument response within the dynamic experimental spatial geometry to produce an initial z₀ sampling of the complicated pressure wavefield recorded by the sensors and exploration-seismology vessel following a pressure impulse. In other words, the result of an exploration-seismology experiment and data collection, where the experiment consists of a single pressure impulse generated by the acoustic source and recording of the sensor output, at millisecond intervals over three to five seconds beginning at a point in time following the initial pressure impulse, is a series of two-dimensional samplings of the complicated wavefield at an initial depth z₀ corresponding to, or corrected from, the sensor depth. Each two-dimensional sampling corresponds to a different point in time.

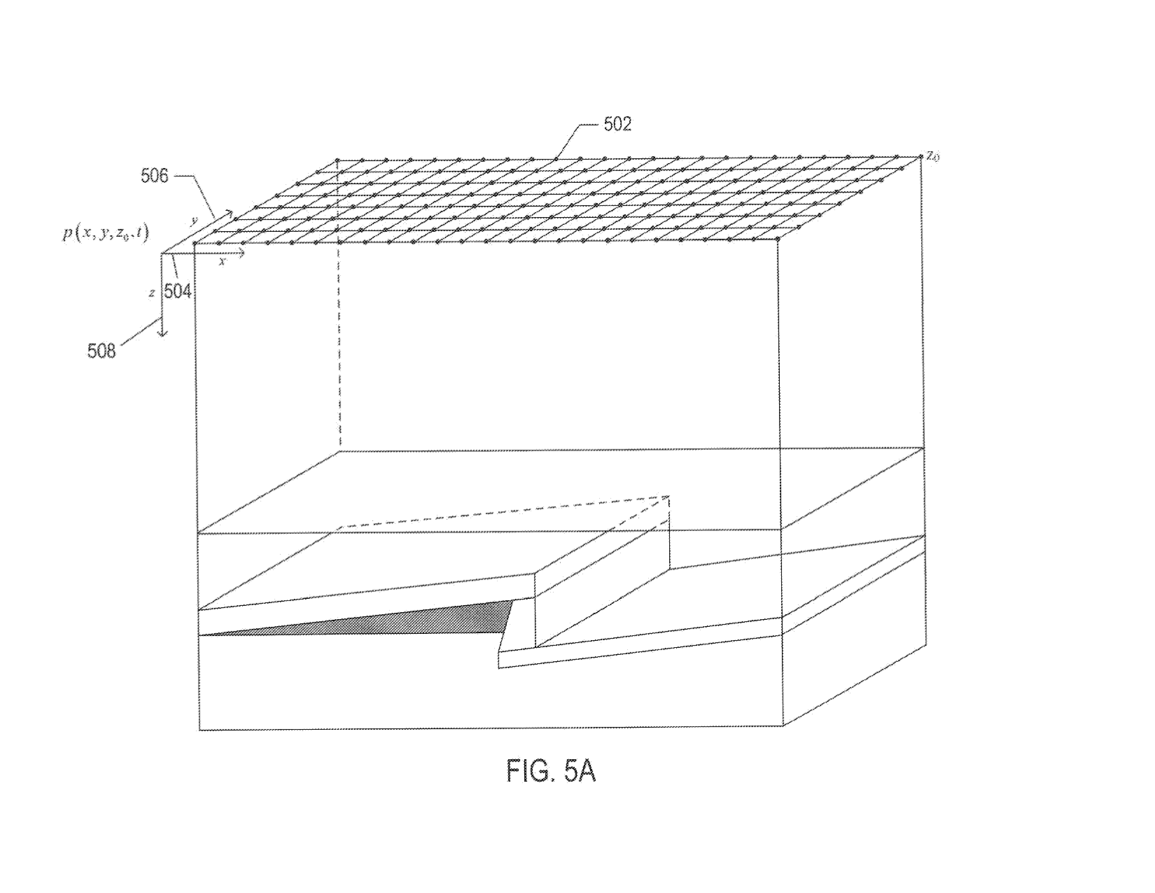

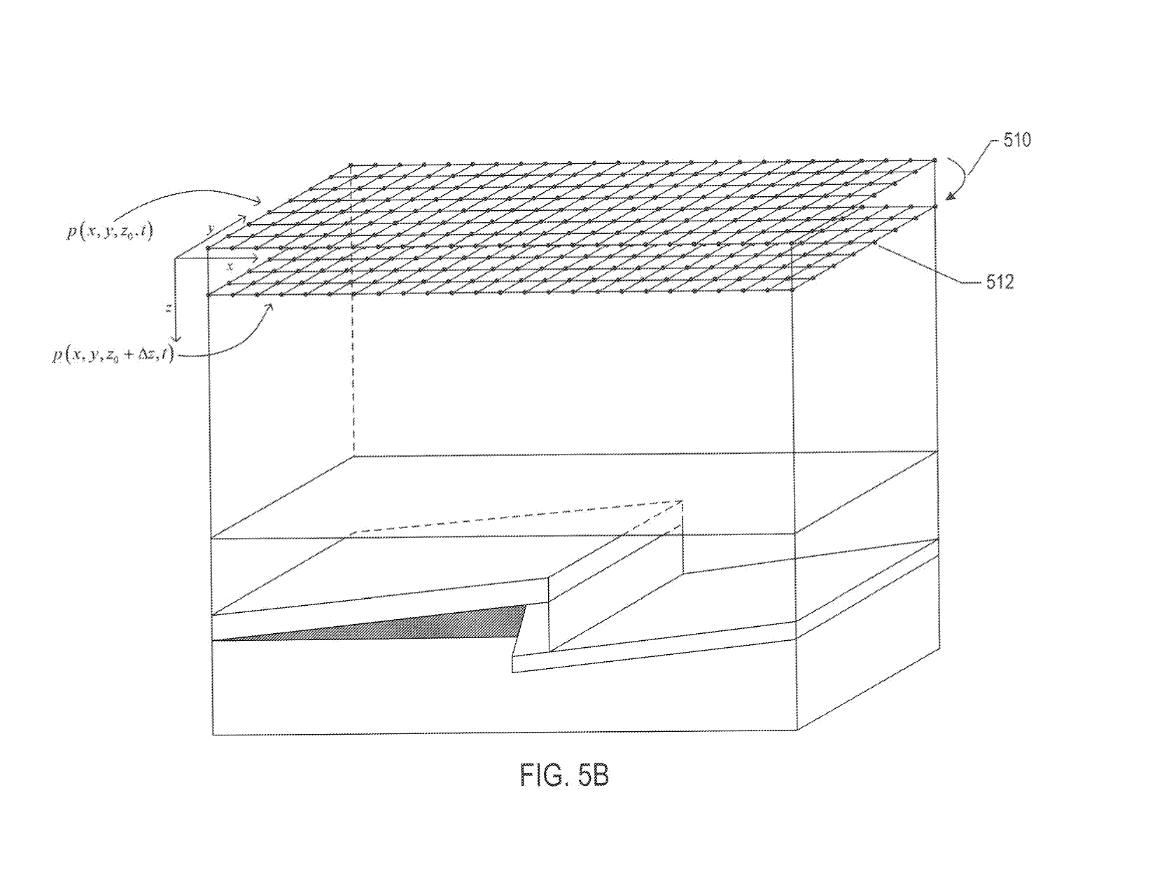

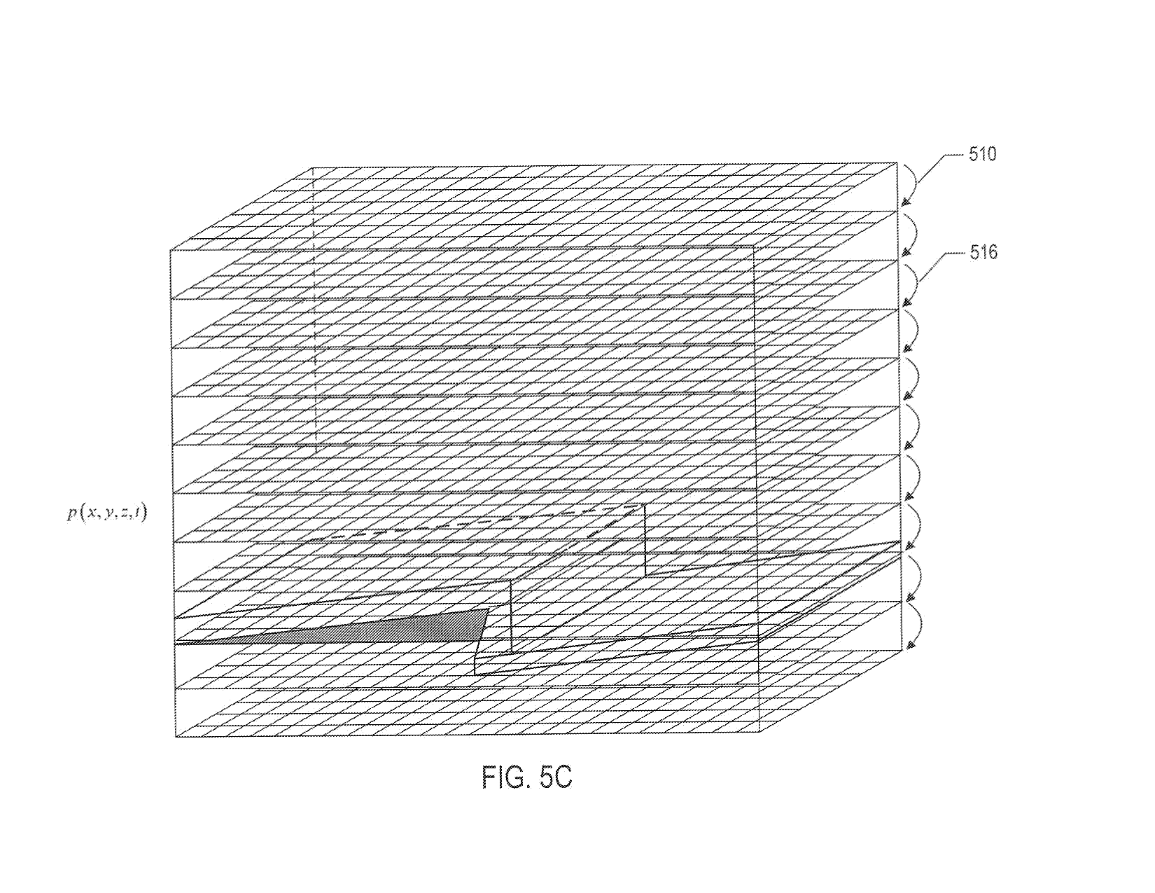

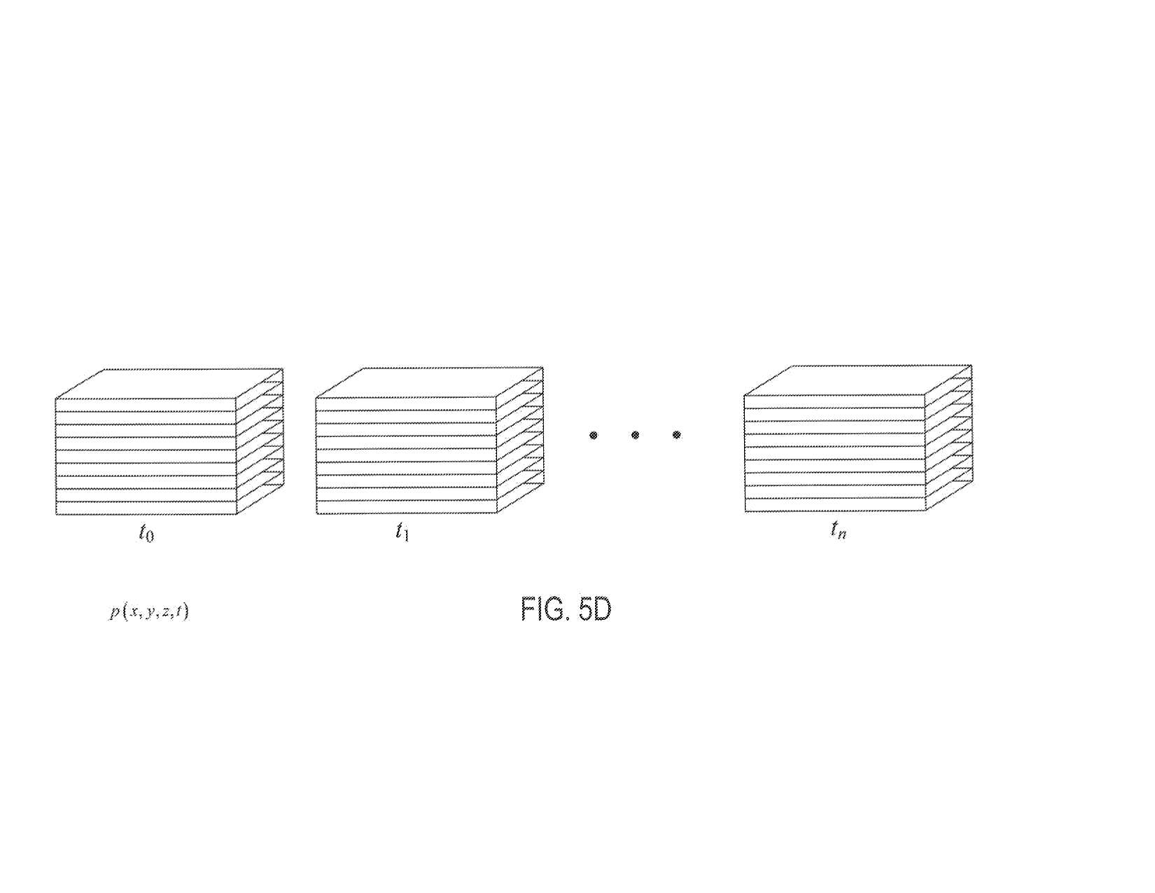

In a next phase of exploration-seismology analysis, a three-dimensional sampling of the complex pressure wavefield is extrapolated from each two-dimensional sampling. FIGS. 5A-D illustrate three-dimensional pressure-wavefield extrapolation. FIG. 5A shows a single two-dimensional sampling of the pressure wavefield at a single point in time generated from the observed data following various initial dynamic-geometry, sensor-position, and sensor-response-related corrections. The full, three-dimensional pressure wavefield can be viewed as a function:

p(x,y,z,i)

that maps a real-number scalar pressure value, or relative pressure differential, to each point in the domain volume represented by spatial coordinates (x,y,z) with respect to time t within a time domain. A constant-depth slice of the three-dimensional pressure wavefield at depth z₀ can be represented as:

p(x,y,z₀,t).

However, there is no closed-form mathematical representation for either the complicated three-dimensional or constant-depth wavefields. Instead, the data generated from the initial sensor-output recordings is a discrete sampling of the pressure or a pressure differential with respect to a reference pressure at the z₀ depth across the domain volume. In FIG. 5A, a grid-like two-dimensional coordinate system is superimposed on the z₀ plane, with each sample point represented by a small filled disk, such as disk 502. For many purposes, a rectangular Cartesian coordinate system is used, with the x axis 504 aligned with the streamer axes and the exploration-seismology-vessel path (304 and 305 in FIG. 3A) and the y axis 506 orthogonal to the streamer direction. The z axis 508 corresponds to depth, with z values increasing with increasing downward distance from the z₀ position. Thus, p(x,y,z₀,t) is a vector or matrix of real-number values stored in one or more data-storage devices within a computer system.

As shown in FIG. 5B, a computational wavefield-extrapolation process can be used to generate an extrapolated sampling at a next depth z₁. This computational process is represented in FIG. 5B by curved arrow 510, and the result of the computational process is an extrapolated sampling of the pressure wavefield at depth z₁, represented in FIG. 5B by the second, lower two-dimensional coordinate grid with sample points 512. Thus, while the sampling of the z₀ constant-depth wavefield p(x,y,z₀,t), shown in FIG. 5A, is obtained by initial processing and correction of the observed data, the sampling of the pressure wavefield at depth z₁, p(x,y,z₁,t), is generated computationally from p(x,y,z₀,t). Please note that the present application is directed particularly to the wavefield-extrapolation computational processing method that is used to extrapolate a sampling of the three-dimensional pressure wavefield at a next lower depth from a sampling of an observed or extrapolated pressure wavefield at a current depth. In other words, the current application is directed to a computational process represented by curved arrow 510 in FIG. 5B and by numerous curved arrows shown in FIG. 5C, discussed below.

As shown in FIG. 5C, the two-dimensional pressure-wavefield sampling extrapolation can be successively applied to produce an extrapolated three-dimensional wavefield for a sub-volume of the domain volume or for the entire domain volume. Each curved arrow, such as curved arrow 516 in FIG. 5C, represents application of the wavefield-extrapolation computational process that extends the sampled three-dimensional wavefield to a next-lowest depth interval. Thus, from each two-dimensional sampling at depth z₀ at different points in time, a full three-dimensional wavefield sampling over the domain volume is generated for the different points in time by wavefield extrapolation. As shown in FIG. 5D, a series of three-dimensional wavefield extrapolations therefore represents a sampling of the full time-dependent pressure wavefield p(x,y,z,t) over both spatial and temporal domains. Please note that the spacings and relative scales of the domain volume, seismic-exploration vessel, streamers, sensors, and depth intervals at which two-dimensional samplings are generated in FIGS. 1-5D are not meant to accurately portray actual spacings and relative scales. Instead, FIGS. 1-5D are intended to illustrate certain general concepts related to exploration-seismology experiment and data-processing.

Please note also that, in many exploration-seismology data-processing applications, constant-time sampling slices are generally not produced during data-processing and seismic analysis. The above discussion and illustration of the three-dimensional time-dependent pressure wavefield p(x,y,z,t) are intended to illustrate the nature of the discrete three-dimensional time-dependent pressure wavefield, rather than to illustrate the data-processing steps and mathematical models employed to transform raw sensor signals collected during experiments into discrete representations of continuous pressure wavefields.

One mathematical model for the acoustic wavefield is a second-order partial differential equation, referred to as the “acoustic-wave equation,” two forms of which are provided below:

$$\begin{matrix}\frac{{\partial }^{2} p}{\partial {t}^{2}} = ρ ( x , y , z ) {υ}^{2} ( x , y , z ) [ \begin{matrix}\frac{\partial }{\partial x} \frac{1}{ρ ( x , y , z )} \frac{\partial p}{\partial x} + \frac{\partial }{\partial y} \frac{1}{ρ ( x , y , z )} \frac{\partial p}{\partial y} + \\ \frac{\partial }{\partial z} \frac{1}{ρ ( x , y , z )} \frac{\partial p}{\partial z}\end{matrix} ] , \\ = ρ {υ}^{2} ▽ \cdot \frac{1}{ρ} ▽ p ,\end{matrix}$$

where

p=p(x,y,z,t)=pressure;

t=time;

x,y,z=special coordinates;

ν=velocity of medium at (x,y,z);

ρ(x,y,z)=density of medium at (x,y,z); and

∇=the del operator.

This partial differential equation relates the time behavior of the pressure wavefield to the spatial structure of the pressure wavefield, and can be derived from Newton's second law and Hooke's law. The acoustic-wave equation corresponds to many different possible pressure wavefields p(x,y,z,t). In general, partial differential equations are solved with respect to certain specified initial values and boundary conditions in order to select-a specific pressure wavefield corresponding to the partial differential equation. For example, in the above-described exploration-seismology experiment, initial values include the location and magnitude of the initial pressure impulse and the boundary conditions include the shapes, sizes, locations, and characteristics of the various reflective interfaces, including the solid surface (106 in FIG. 1), the depth of the solid surface below the fluid surface, and the shapes, sizes, and locations of the subsurface features, including interfaces between rock layers. As noted above, the observed and extrapolated pressure wavefield p(x,y,z,t) is not a mathematical expression, but is instead stored data.

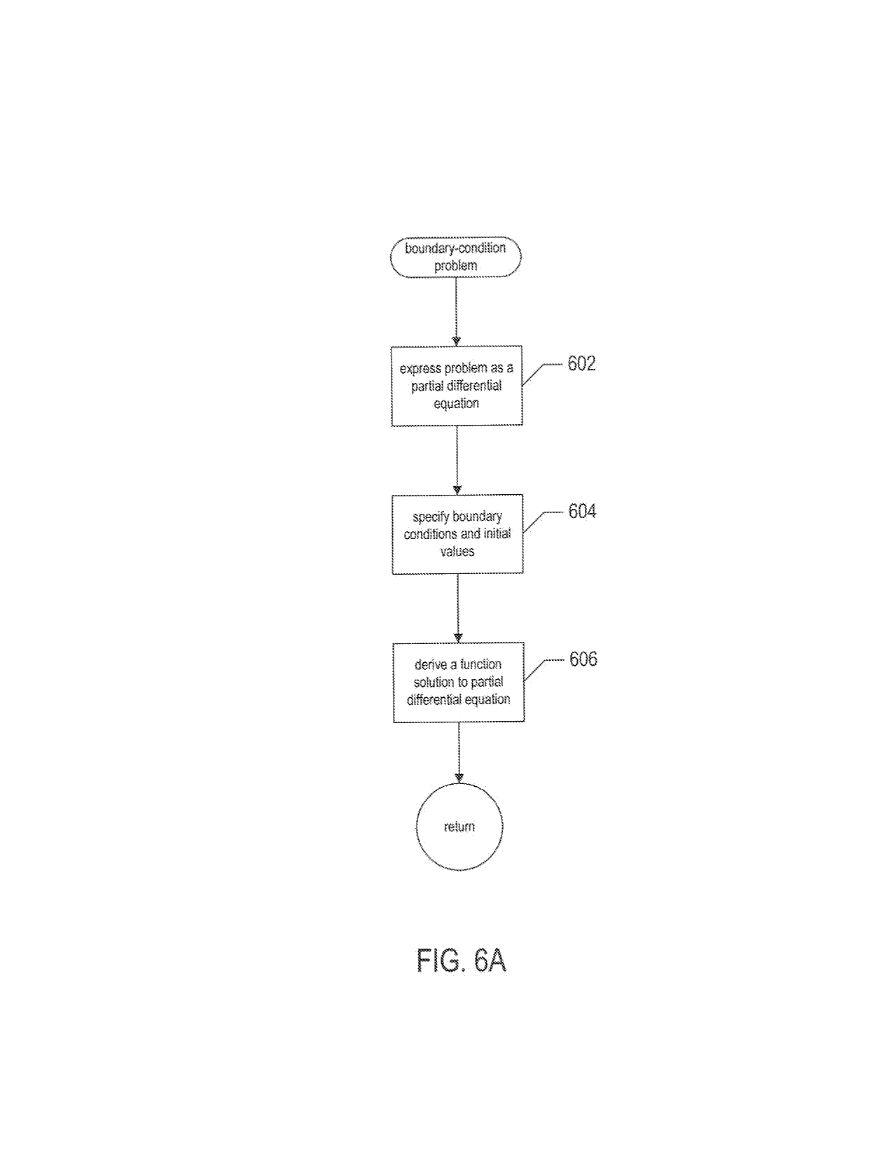

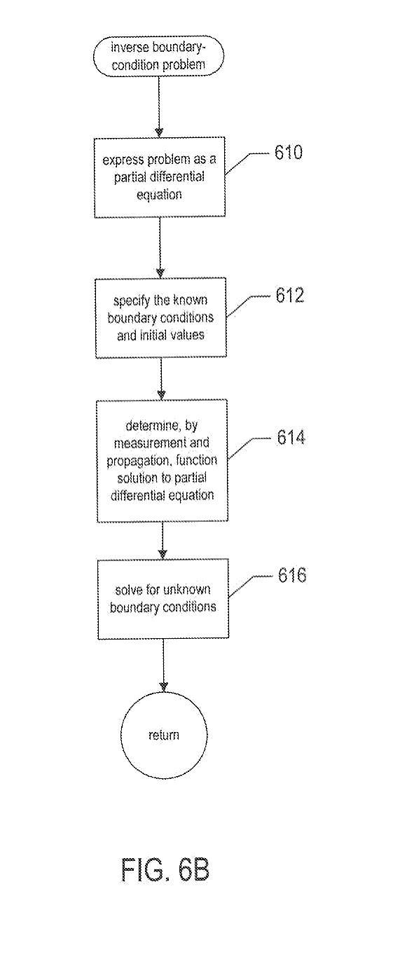

FIG. 6A illustrates solving a normal partial-differential equation boundary-condition problem. In a first step 602, the problem is expressed or represented, as a partial differential equation, such as the above-provided acoustic-wave partial differential equation. Next, the various initial values and boundary conditions for a specific problem are specified mathematically. Finally, a specific solution of the partial differential equation is derived with respect to the specified boundary conditions and initial values. As an example, by providing a full characterization of the domain volume, as shown in FIG. 2, as well as the time, location, and magnitude of the initial pressure impulse, the acoustic-wave partial differential equation can be numerically solved to produce the pressure wavefield p(x,y,z,t). However, as discussed above, in exploration-seismology analysis, the data obtained during a seismic experiment provide an extrapolated, sampled pressure wavefield p(x,y,z,t), while various boundary conditions, including the structure and distribution of subsurface features, are not known. Therefore, at a high level, exploration-seismology data analysis constitutes a type of inverse boundary-condition problem which is solved to determine certain of the boundary conditions that were not known when the exploration-seismology experiment was conducted. FIG. 6B illustrates solving an inverse boundary-condition problem. In step 610, the problem is expressed as a partial differential equation, as in step 602 of FIG. 6A. Next, in step 612, those boundary conditions that can be specified as well as the initial values are mathematically specified. In step 614, a discrete pressure wavefield or other specific discrete solution to the partial differential equation is constructed from experimental observation and, in the exploration-seismology context, computational wavefield extrapolation. Finally, in step 616, those boundary conditions that were not known and specified in step 612 are solved for from the observed data, partial differential equation, and specified known boundary conditions and initial values. Thus, the general exploration-seismology analysis constitutes an inverse boundary-condition-problem solution.

Please note that, in the exploration-seismology analysis discussed above, the partial differential equations and solutions to partial differential equations are expressed discretely and computationally, rather than continuously and analytically. The pressure wavefield p(x,y,z,t) is computationally represented as a sampling of a real-valued scalar field. The sampling parameters vary with different types of sensors, streamer configurations, experimental conditions, computational bandwidth, and data-storage and data-manipulation capacities of the computer systems employed to carry out the exploration-seismology analysis. In many cases, the x, y, and z sampling intervals range between 10 and 30 meters and the domain volume may have x, y, z dimensions of 5-10 kilometers, 5-10 kilometers, and 0.5-10 kilometers, respectively, and many thousands of extrapolation steps may be involved in generating a three-dimensional pressure wavefield for exploration-seismology applications. However, both the sampling intervals and domain-volume dimensions may vary considerably depending on experimental equipment, methods, and conditions.

The pressure wavefield is most easily thought of as being represented in the space-time domain, as discussed above. In other words, the pressure wavefield can be viewed as a function of position in three-dimensional space, represented by the vector r, and time t:

p(r,t).

Alternatively, the pressure wavefield can be expressed or represented in a wave-vector, angular-frequency domain or, equivalently, a wavenumber-angular-frequency domain:

P(k,w).

The wave vector k has spatial components kₓ, k_{y}, and k_{z} and is normal to a wavefront and has a magnitude inversely proportional to wavelength of the wave producing the wavefront. The angular frequency ω is 2πv, where v is the frequency of the wave in cycles per unit time.

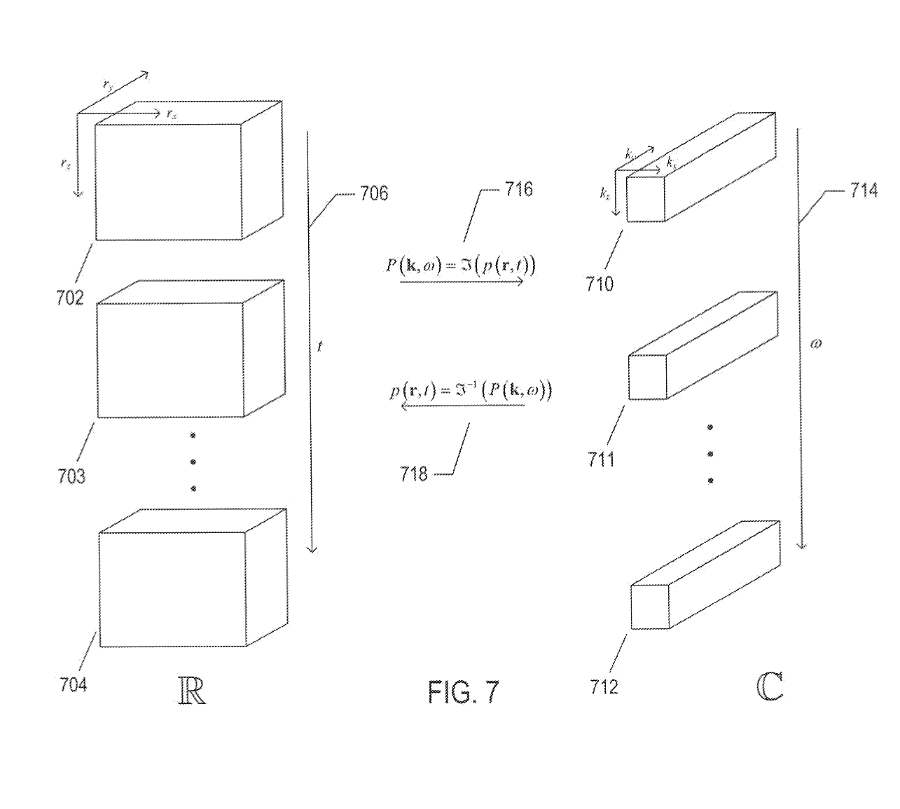

FIG. 7 illustrates two different representations of an acoustic wavefield. The space-time representation, p(r,t) is represented in the left-hand side of FIG. 7 as a series of three-dimensional scalar pressure or pressure-differential fields 702-704 ordered along a time axis 706 while the wavenumber-angular-frequency representation of the wavefield is shown in the right-hand side of FIG. 7 as a series of three-dimensional wave-number representations of superimposed waves 710-712 ordered along an angular frequency axis 714. A point in a three-dimensional pressure scalar field, such as scalar field 702, represents the pressure or a pressure differential at a particular point in space. A particular plane wave with a particular direction and frequency would be represented in space-time as periodically varying pressure within the entire three-dimensional volume. By contrast, a point in the three-dimensional wave-vector space 710 represents a particular plane wave. The plane wave is characterized by the wave vector as well as by the angular frequency of the plane wave. The space-time and wavenumber-angular-frequency representations of a pressure wavefield contain equivalent information. In general, a space-time representation is a scalar real number field over three spatial dimensions and one temporal dimension while the wavenumber-angular-frequency representation is a complex-number field, or vector field, over three wave-vector component dimensions and an angular frequency dimension. The wavenumber-angular-frequency representation of the pressure field is generated by a forward Fourier transform 716 of the space-time representation, and the space-time representation of the pressure wavefield is generated by an inverse Fourier transform of the wavenumber-angular-frequency 718. Expressions for the Fourier transforms are provided below:

$$p ( r , t ) = {( \frac{1}{2 π} )}^{3} {\int }_{w} {\int }_{k} P ( k , ω ) {e}^{i ( k \cdot r + ω t )} d k d ω , \\ P ( k , ω ) = {\int }_{t} {\int }_{r} p ( r , t ) {e}^{- i ( k \cdot r + ω t )} d r d t ,$$

where

r=vector pointing to a point within x,y,z space;

t=time;

k=wave vector;

ω=angular frequency;

p(r,t)=pressure at point r at time t;

P(k,ω)=is related to amplitude of wave with wave vector k and angular frequency ω contributing to p(r,t).

Similarly, the pressure wavefield can also be expressed in a space-angular-frequency domain corresponding to forward and inverse Fourier transforms:

$$p ( r , t ) = \frac{1}{2 π} {\int }_{t} P ( r , ω ) {e}^{- i ω} d ω , \\ P ( r , ω ) = {\int }_{t} p ( r , t ) {e}^{i ω t} d t .$$

The space-time, wavenumber-angular-frequency, and space-angular-frequency domains are examples of domains for various representations of acoustic wavefields. A variety of mathematical transforms can be used to transform the space-time representation of an acoustic wavefield to alternative representations, in addition to Fourier transforms. In general, a wavefield can be transformed from a first domain to a second domain by an appropriate first transform and can be transformed from the second domain to the first domain by a second inverse transform corresponding to the first transform. In the following, a space-time representation of a wavefield may be referred to, as an example, a “first-domain wavefield” and the corresponding wavenumber-angular-frequency representation may be referred to as a “second-domain wavefield.”

### An Example Acoustic-Wave Solution Method

Next, an example of a computational solution of the acoustic-wave equation is provided. In this solution, the second-order partial differential equation is transformed into a pair of ordinary differential equations and the solution is generated by propagating the pressure wave forward in time. This example is provided to illustrate computational, discrete methods for solving the acoustic-wave equation in a relatively simple, easily understood context. This discussion need not be read by those familiar with computational solutions to the acoustic-wave equation. The example is taken from the article “Time-domain Numerical Solution of the Wave Equation” by Jaakko Lehtinen published on Feb. 6, 2003.

In the following, a time-dependent pressure field u(t,x) solution to the wave equation is determined, with xεΩ where Ω denotes the set of points inside the environment to be simulated and t>0. The solution u to the equation is a scalar function over the three spatial dimensions and time that assigns an acoustic sound pressure for each point x in the environment for each t.

For the following example wave-equation solution process, the wave equation can be expressed as:

$$\frac{{\partial }^{2} u}{\partial {t}^{2}} = {c}^{2} {▽}^{2} u + f \qquad ( 1 )$$

where c is the speed of sound, which is assumed to be constant. The equation thus relates the second time derivative of the pressure to its spatial Laplacian ∇²u, with ƒ=ƒ(t,x) representing time-dependent force terms. The force terms ƒ(t,x) represent sources of disturbances in pressure, or the sound sources. Usually, the wave equation is solved with ƒ describing an initial impulse. The solution of the wave equation then describes the time-dependent propagation of the impulse in the environment.

There is no unique solution for equation (1). However, when boundary conditions that represent how the boundaries of the environment reflect sound waves are specified as values of u(t,x) on the boundaries of the environment or as the values of the normal derivatives ∇u·n of u(t,x) where the vectors n are the outward unit normal at boundary points, and, in addition, when various initial values are also specified, including an initial pressure distribution u(0,x) and an initial velocity distribution

$$\frac{\partial u ( 0 , x )}{\partial t} ,$$

a unique solution for equation (1) along with the specified boundary conditions and initial conditions may be determined.

Consider one-dimensional, continuous, bounded, real-valued functions defined on the interval [0,1]. In order to represent a general function, a large but finite number N of equidistant sample points xᵢ, with i=1, . . . , N, may be selected within the interval and the values of the general function at the sample points may be computed and stored. The distance between two sample points is denoted by h. Consider calculation of the derivatives of the function which we have represented by function values at sample points. One class of methods is suggested by the difference quotient that is used to define the derivative in the continuous case. This yields the approximations

$$\begin{matrix}{f}^{′} ( {x}_{i} ) \approx \frac{f ( {x}_{i + 1} ) - f ( {x}_{i} )}{h} , & ( 2 ) \\ {f}^{′} ( {x}_{i} ) \approx \frac{f ( {x}_{i} ) - f ( {x}_{i - 1} )}{h} , \\ and & ( 3 ) \\ {f}^{′} ( {x}_{i} ) \approx \frac{f ( {x}_{i + 1} ) - f ( {x}_{i - 1} )}{2 h} , & ( 4 )\end{matrix}$$

which are called forward difference, backward difference and central difference, respectively.

A Taylor-series expansion provides an approximation for the second derivative:

$$\begin{matrix}f ( x + h ) = f ( x ) + \frac{ {h}^{1}}{1 !} {f}^{′} ( x ) + \frac{{h}^{2}}{2 !} {f}^{″} ( x ) + \frac{{h}^{3}}{3 !} {f}^{′′′} ( x ) + O ( {h}^{4} ) , & ( 5 ) \\ f ( x - h ) = f ( x ) - \frac{ {h}^{1}}{1 !} {f}^{′} ( x ) + \frac{{h}^{2}}{2 !} {f}^{″} ( x ) - \frac{{h}^{3}}{3 !} {f}^{′′′} ( x ) + O ( {h}^{4} ) , & ( 6 ) \\ {f}^{″} ( x ) = \frac{f ( x - h ) - 2 f ( x ) + f ( x + h )}{{h}^{2}} + O ( {h}^{2} ) . & ( 7 )\end{matrix}$$

By writing values of the function at the sample points of the function u as an N-dimensional vector uₕ, the difference approximations can be written in a matrix form so that multiplication of the vector uₕ of function values with the matrix produces a new vector approximating the values of the derivative or second derivative at the sample points. These matrices have a banded structure, with nonzero elements found along or neighboring the diagonal elements:

$${D}_{h} = \frac{1}{2 h} [ \begin{matrix} & 1 & & & & \\ - 1 & & 1 & & & \\ & - 1 & & 1 & & \\ & & ⋱ & & ⋱ & \\ & & & - 1 & & 1 \\ & & & & - 1 & \end{matrix} ]$$

$$and$$

$${Δ}_{h} = \frac{1}{{h}^{2}} [ \begin{matrix}- 2 & 1 & & & & \\ 1 & - 2 & 1 & & & \\ & 1 & - 2 & 1 & & \\ & & ⋱ & & ⋱ & \\ & & & 1 & - 2 & 1 \\ & & & & 1 & - 2\end{matrix} ] ,$$

where 0-valued elements are omitted. Dₕuₕ is a central difference approximation to the first derivative of the function u with samples placed h units apart and Δₕuₕ is a central difference approximation of the second derivative. The values for the ends of the interval are dependent on the initial and boundary conditions of the differential equation.

Differentiation can thus be seen as an operator that acts on a function and produces another function. For discretized functions, discretized differentiation operator is represented by a matrix. This is a consequence of differentiation being a linear operation in the continuous case.

By using the discretized representation Δₕ for the second derivative, a semidiscrete version of the one-dimensional wave equation can be derived by substituting uₕ for u and substituting Δₕuₕ for ∇²u:

uₕ⁻=c²Δₕuₕ+fₕ, (8)

where fₕ denotes the values of the function ƒ at the sample points and primes denote differentiation with respect to time. The semidiscretized form of the wave equation is no longer a partial differential equation. Instead, it is an ordinary differential equation in N unknowns with the unknown vector uₕ, whose elements are the values of the function u at the sample points xᵢ. This equation can be solved with any standard method for integrating differential equations with respect to time.

The one-dimensional difference approximations are easily extended to two or more dimensions. For instance, the gradient operator ∇ in 3 dimensions is easily implemented with one-dimensional finite differences along each coordinate axis. The Laplacian operator can be expressed as:

$$\begin{matrix}Δ u {\vert}_{( ih , jh )} \approx \frac{{u}_{h} ( i + 1 , j ) - 2 {u}_{h} ( i , j ) + {u}_{h} ( i - 1 , j )}{{h}^{2}} + \\ \frac{{u}_{h} ( i , j + 1 ) - 2 {u}_{h} ( i , j ) + {u}_{h} ( i , j - 1 )}{{h}^{2}} \\ = \frac{\begin{matrix}{u}_{h} ( i + 1 , j ) + {u}_{h} ( i - 1 , j ) + {u}_{h} ( i , j + 1 ) + \\ {u}_{h} ( i , j - 1 ) - 4 {u}_{h} ( i , j )\end{matrix}}{{h}^{2}}\end{matrix} \qquad ( 9 )$$

two dimensions, where the two-dimensional domain has been discretized into a regular grid of sample points, with the values of the function u at the sample points stored in a matrix uₕ. The three-dimensional case is analogous. Writing the difference approximation from equation (9) into a matrix form can be achieved by first stacking the columns of uₕ into a long column vector, after which corresponding matrix expressions can be derived.

A fully discrete solution of the wave equation can be obtained by time stepping. The process is called integrating the differential equation. The semidiscretized equation can be expressed as

$$\{ \begin{matrix}{u}_{h}^{″} = {c}^{2} {Δ}_{h} {u}_{h} + {f}_{h} , & x ∈ Ω ( equation of motion ) \\ {u}_{h} ( 0 , x ) = {u}_{h}^{0} ( x ) , & ( initial condition for {u}_{h} ) \\ {u}_{h}^{′} ( 0 , x ) = {v}_{h}^{0} ( x ) , & ( initial condition for {u}_{h}^{′} )\end{matrix}$$

where uₕ⁰ and vₕ⁰ are predefined functions defined over the spatial discretization. This is a second-order system of ordinary differential equations in N unknowns.

Most integration methods apply to first-order differential equations. Higher-order problems can be transformed into first-order problems by introducing new variables. To transform the semidiscretized wave equation into a first-order system, a new variable

$${v}_{h} = \frac{d {u}_{h}}{d t}$$

is defined so that equation (8) takes the form

$$\{ \begin{matrix}\frac{d {v}_{h}}{d t} = {c}^{2} {Δ}_{h} {u}_{h} + {f}_{h} \\ \frac{d {u}_{h}}{d t} = {v}_{h}\end{matrix} \qquad ( 10 )$$

This has the effect of doubling the number of unknowns, since there are now two vectors of length N to solve for. Equations 10 can be further simplified by concatenating the vectors uₕ and vₕ into a new vector w:

$$\frac{d w}{d t} = A w + g , \\ with$$

$$w = [ \begin{matrix}{u}_{h} \\ {v}_{h}\end{matrix} ] , g = [ \begin{matrix}0 \\ {f}_{h}\end{matrix} ] , A = [ \begin{matrix}0 & I \\ {c}^{2} {Δ}_{h} & 0\end{matrix} ] , \\ and$$

$$w ( 0 ) = [ \begin{matrix}{u}_{h}^{0} \\ {v}_{h}^{0}\end{matrix} ] ,$$

where each element of A, printed in bold, denotes a N×N submatrix and I denotes the identity matrix. The numerical solution of the above system is a discrete sequence w^{k}, kε [symbol] , of vectors corresponding to values, of the solution w at different timesteps.

### An Efficient Wavefield-Extrapolation Computational Processing Method as an Example of Computational Processing Methods and Systems to which the Current Application is Directed

Both time and depth extrapolation of a pressure wavefield is based on the acoustic wave equation which, as discussed above, is a second-order linear partial differential equation. The efficient wavefield-extrapolation computational processing method discussed in this subsection can be used for extrapolating a lower-dimensional projection of a pressure wavefield to a higher-dimensional wavefield along any spatial or temporal dimension. As an example, the extrapolation computational processing method is discussed in the context of extrapolating a constant-depth slice to three-dimensional wavefield along the z spatial dimension, as illustrated in FIGS. 5A-C. However, extrapolation can also be carried out along either of the x and y spatial dimensions or along the temporal dimension t. For depth extrapolation, this second-order linear partial differential equation and can be equivalently expressed by a system of two first-order linear ordinary differential equations (“ODEs”) as follows:

$$\frac{\partial }{\partial z} ( \begin{matrix}P \\ {P}_{z}\end{matrix} ) = ( \begin{matrix}0 & 1 \\ G & 0\end{matrix} ) ( \begin{matrix}P \\ {P}_{z}\end{matrix} ) , \qquad ( 11 )$$

where

$$\frac{\partial }{\partial z}$$

is the first-order partial differential operator with respect to depth z; the two first-order linear ODEs are expressed in matrix-vector form; P is total pressure; Pz is the normal derivative of pressure P; and G is an acoustic-wave-equation-related operator. To solve equation (11) with given boundary conditions, the above matrix is normally reduced to a diagonal matrix by the eigenvalue decomposition method. Employing a “flat thin slab” model widely applied in depth extrapolation, the following matrix-form equations are derived from matrix-form equations (11) after applying the eigenvalue decomposition:

$$\frac{\partial }{\partial z} ( \begin{matrix}P u \\ P d\end{matrix} ) = ( \begin{matrix}λ & 0 \\ 0 & λ *\end{matrix} ) ( \begin{matrix}P u \\ P d\end{matrix} ) , \qquad ( 12 )$$

where Pu and Pd denote up-going and down-going wavefields respectively, and are expressed in any of the space-time, space-angular frequency, or wavenumber-angular frequency domains. In this discussion, a wavenumber-angular frequency expression and domain is implied when the representation and domain are not explicitly stated. λ and λ* are two eigenvalues of the matrix in equation (11), also called “square root operators” for up-going and clown-going waves, respectively. Mathematically, λ and λ* are conjugate in the exploration-seismology context. In most currently practiced exploration-seismology data-processing and analysis methods, only a single equation of equation (12) is employed, and therefore only a single one-way operator is applied to a corresponding one-way wavefield. One-way methods are currently used because they are simple and efficient and because, in most exploration seismic experiments, only one-physical quantity is measured, such as pressure in single-sensor-type marine exploration seismology. In the one-way methods, one of following decoupled one-way equations is generally applied individually:

$$\begin{matrix}\frac{\partial }{\partial z} ( P u ) = λ P u , \\ and & ( 13 ) \\ \frac{\partial }{\partial z} ( P d ) = λ * P d . & ( 14 )\end{matrix}$$

The solutions of one-way equations (13) and (14) with the Dirichlet boundary condition, for up-going and down-going waves, are well known as follows:

Pu(z)=L Pu(z₀), (15)

and

Pd(z)=L*Pd(z₀), (16)

where z₀ and z, denote the depth of top and bottom interfaces of a “flat thin slab” extrapolation model embedded in an inhomogeneous horizontally layered media. When the slabs have identical thicknesses, the difference Δz=z−z₀ is the depth interval for each extrapolation step. One-way propagators L and L* in equations (15) and (16) are defined as follows:

L=exp(λΔz), (17)

and

L*=exp(λ*Δz), (18)

where exp( ) denotes the exponential function, so that exp(x)=e^{x}. For a constant velocity “flat thin slab” model, equations (17) and (18) can be exactly reduced to the well known one-way propagators:

L=exp(−j K_{z}Δz), (19)

and

L*=exp(j k_{z}Δz), (20)

where k_{z} is the vertical wavenumber; and j is imaginary number, or \sqrt{−1}. Please note that operators λ and λ* and L and L* in above equations (12)-(20) are conjugate pairs, independent of whether the velocity medium is constant or varied.

In two-sensor-type exploration-seismology experiments, using, as one example, sensor pairs comprising a hydrophone and a geophone, the sampled wavefield can be straightforwardly partitioned into up-going and down-going wavefields, since the vertical fluid velocity is a signed quantity. This is also true when multi-component ocean-bottom cable are employed, the cables including four-component sensors comprising a hydrophone and a sensor for each of the three spatial components of particle velocity, or any of various other similar exploration-seismology instrumentation. In all such cases, initial boundary conditions for both pressure and the derivative of pressure with respect to depth, or equivalently, for both up-going and down-going waves, are known. In these cases, two-way full wave field depth extrapolation is feasible and carried out by two conventional methods.

The first two-way-extrapolation method is straightforward. From equations (15) and (16):

P(z)=Pu(z)+Pd(z)=L Pu(z₀)+L*Pd(z₀), (21)

and

Q(z)=Pd(z)−Pu(z)=L*Pd(z₀)−L Pu(z₀), (22)

where P is a summation of the up-going wavefield and down-going wavefield, a two-way full wavefield representation related to the total pressure; and Q is the difference between down-going and up-going wavefields, another two-way full wavefield representation related to the vertical component of particle velocity Vz and pressure derivative with respect to depth Pz as follows:

Q=(pω/k_{z})Vz, (23)

and

Q=(−j/k_{z}Pz, (24)

where ρ is volume density; and ω is angular frequency.

Based on equations (21) and (22), two-way full wavefields P and Q at depth z are obtained by a downward or upward extrapolation of both up-going and down-going waves at depth z₀ using corresponding one-way operators, followed by a summation and subtraction process.

The second method of two-way wavefield extrapolation is derived starting from the relationship between one-way wavefields Pu and Pz and two-way wavefields P and Q, as defined in equations (21) and (22) and by expressing Pu(z₀) and Pd(z₀) in terms of P(z₀) and Q(z₀):

Pu(z₀)=(½)[P(z₀)−Q(z₀)], (25)

and

Pd(z₀)=(½)[P(z₀)+Q(z₀)], (26)

and by then substituting (25) and (26) into (21) and (22). The following formulas of the second method for extrapolating two-way full wavefield are obtained:

P(z)=P(z₀)(½)(L+L*)+Q(z₀)½)(L*−L), (27)

and

Q(z)=P(z₀)(½)(L*−L)+Q(z₀)½)(L+L*), (28)

In contrast to terms L and L* in equations (15) and (16) denoting Green functions for one-way wavefield propagation, terms ½ (L+L*) and ½ *(L*−L) in equations (27) and (28) are Green functions for two-way full wavefield propagation. Using the conjugate relationship that exists between L and L*, the following simplification is made for the two-way Green functions:

Re(L)=Re(L*)=(½)(L+L*), (29)

and

−j Im(L)=j Im(L*)=(½)(L*−L), (30)

where Re( ) and Im( ) denote respective real and imaginary parts of a complex variable or function, i.e. L=Re(L)+j Im(L) and L*=Re(L*)+j Im(L*). Substituting (29) and (30) into (27) and (28) provides two simplified equations for two-way full wavefield extrapolation:

P(z)=P(z₀)Re(L)−j Q(z₀)Im(L), (31)

and

Q(z)=−j P(z₀)Im(L)+Q(z₀)Re(L) (32)

Equations (31) and (32) are equivalent to equations (27) and (28). In both cases, only one of one-way operators L and L* is now involved, and only a multiplication between a complex vector representing the two-way wavefield and a real vector representing the real and imaginary parts of the one-way operator is involved in equations (31) and (32).

The above two methods for two-way full-wavefield extrapolation, based on equations (21) and (22), and equations (31) and (32), respectively, are equivalent, not only in accuracy but also in efficiency. In order to complete a two-way full-wavefield extrapolation for each step, from depth z₀ to z, by the first method of equations (21) and (22), each one-way complex wavefield, Pu(z₀) and Pd(z₀), is multiplied by a complex one-way extrapolation operator, L or L*, and the two complex products are added to produce complex wavefield P(z) and subtracted to produce complex wavefield Q(z). Thus, for each propagation step, with 17 equal to the number of sample points in a two-dimensional, constant-depth slice of the complex wavefield, 2n complex-number multiplications and 2n complex additions are carried out, considering subtraction to be computationally equivalent to addition.

In order to complete a two-way full-wavefield extrapolation for each step, from depth z₀ to z, by the second method of equations (31) and (32), the complex wavefields P(z₀) and Q(z₀) are multiplied twice by a real number to produce 4 complex wavefields, one pair of which is added and another pair of which is subtracted. Thus, for each propagation step, 4n multiplications between a complex and a real number and 2n complex additions are carried out. Given that the computational cost of a complex multiplication is twice that of a multiplication between a real number and a complex number, the computational cost of the first method is equivalent to the computational cost of the second method:

$$cost of complex multiplication = {M}_{cc} , \\ \begin{matrix}cost of a complex \text{-} real multiplication = {M}_{cr} \\ = {M}_{cc} / 2 ,\end{matrix}$$

$$cost of a complex addition = {A}_{cc} , \\ cost of first method = 2 n ( {M}_{cc} ) + 2 n ( {A}_{cc} ) , \\ \begin{matrix}cost of second method = 4 n ( {M}_{cr} ) + 2 n ( {A}_{cc} ) , \\ = 2 n ( {M}_{cc} ) + 2 n ( {A}_{cc} ) , \\ = cost of the first method .\end{matrix}$$

The current application is directed to an alternative, new two-way full-wavefield extrapolation computational processing method that is associated with a significantly lower computational cost than above-described conventional methods. First, two virtual complex wavefields s and r are defined in the space-time domain:

s=p+j q, (33)

and

r=p−j q, (34)

where p and q are linear, combinations, summation and difference, of the real-valued up-going wave pᵤ and down-going wave p_{d}, defined as follows:

p=pᵤ+p_{d}, (35)

and

q=p_{d}−pᵤu. (36)

The pair of virtual complex-valued wavefields s and r is conjugate because both p and q, defined in equations (25) and (26), are real-valued wavefields. Based on the definition of P and Q given in equations (21) and (22), P and Q are counterparts of p and q in the wavenumber-angular frequency domain, generated by a forward Fourier transform:

P=ℑ(p), (37)

and

Q=ℑ(q), (38)

where ℑ denotes a Fourier transform from the space-time domain to the wavenumber-frequency domain. Based on equations (33), (34) and (37), and (38), the complex-valued wavefields s and r are transformed to virtual-complex-valued-wavefield counterparts in the wavenumber-angular-frequency domain:

s=ℑ(s)=P+j Q, (39)

and

R=ℑ(r)=P−j Q. (40)

Note that, although a Fourier transform generally transforms a real-valued wavefield to a complex-valued wavefield, the Fourier transform generally transforms a complex-valued wavefield in a first domain to a, complex-valued wavefield iii a second domain.

Although virtual complex-valued wavefields s and r are conjugate, virtual complex-valued wavefields S and R are not, in general, conjugate, since both P and Q in equations (29) and (30) are complex wavefields. By substituting equations (21) and (22) into equations (39) and (40), and also using relation equations (29) and (30) that define Re(L) and Im(L), the following propagation equations are obtained:

S(z)=S(z₀)Re(L)+R(z₀)Im(L), (41)

and

R(z)=−S(z₀)Im(L)+R((z₀)Re(L), (42)

where S(z₀), R(z₀) and S(z), R(z) denote values of virtual complex-valued wavefields S and R at depth z₀ and depth z respectively; and Re(L) and Im(L) are both real and are defined as in (29) and (30).

Applying an inverse Fourier transform to S(z) or R(z), the space-time counterparts s(z) or r(z) are obtained as:

s(z)=ℑ⁻¹[S(z)]=p(z)+j q(z), (43)

and

r(z)=ℑ⁻¹[R(z)]=p(z)−j q(z). (44)

From either the complex-valued wavefield s(z) or r(z), the real wavefields p(z) and q(z) are obtained as the real and imaginary parts of either s(z) or r(z), according to equations (33) and (34).

There are two interesting features with respect to the new two-way full wavefield extrapolation computational processing method expressed as equations (33)-(44). First, the two-way full wavefield extrapolation can be carried out using a single propagation step to propagate either S(z₀) to S(z) or R(z₀) to R(z). This is because the solution, p(z) and q(z), can be obtained by a natural separation of real and imaginary parts from a single complex wavefield, either s or r, without using both s and r simultaneously. Second, because only one equation is used to complete depth extrapolation for each step, the computational cost is 2n complex-real multiplications and n complex additions:

$$\begin{matrix}cost of new method = 2 n ( {M}_{cr} ) + n ( {A}_{cc} ) , \\ = n ( {M}_{cc} ) + n ( {A}_{cc} ) , \\ = \frac{1}{2} ( cost of first method ) , \\ = \frac{1}{2} ( cost of second method ) .\end{matrix}$$

Comparing the cost anew method with the costs of the first and second conventional methods, above, the new method reduces the calculation cost of each propagation step by a factor of ½ and increases the calculation efficiency by a factor of 2. Therefore, the new method significantly reduces the cost involved in the depth extrapolation process which normally includes thousands of iterative depth extrapolation steps for typical exploration-seismology data processing applications, including modeling, migration, and inversion.

Equations (41) and (42) of the new method can alternatively be derived from equations (31) and (32) as follows. Equations (31) and (32) can be expressed in matrix form:

$$\begin{matrix}( \begin{matrix}P ( z ) \\ Q ( z )\end{matrix} ) = A ( \begin{matrix}P ( {z}_{0} ) \\ Q ( {z}_{0} )\end{matrix} ) , \\ where & ( 45 ) \\ A = ( \begin{matrix}{R}_{c} ( L ) & - j {1}_{m} ( L ) \\ - j {1}_{m} ( L ) & {R}_{c} ( L )\end{matrix} ) . & ( 46 )\end{matrix}$$

Based on matrix theory, matrix A can be equivalently expressed by its similarity transformation B as

A=M⁻¹BM, (47)

and, correspondingly,

B=MAM⁻¹, (48)

where M and its inverse M⁻¹ are related similarity transform matrices. Define the matrix M and its inverse M⁻¹, with specified constant coefficients, as follows:

$$\begin{matrix}M = ( \begin{matrix}1 & j \\ 1 & - j\end{matrix} ) , \\ and & ( 49 ) \\ {M}^{- 1} = ( \frac{1}{2} ) ( \begin{matrix}1 & 1 \\ - j & j\end{matrix} ) , & ( 50 )\end{matrix}$$

where j is imaginary number \sqrt{−1}. Inserting equation (47) into to equation (45), equation (45) is rewritten as follows:

$$( \begin{matrix}P ( z ) \\ Q ( z )\end{matrix} ) = {M}^{- 1} B M ( \begin{matrix}P ( {z}_{0} ) \\ Q ( {z}_{0} )\end{matrix} ) . \qquad ( 51 )$$

From equation (51) new vector functions S and R are defined as linear combinations of vectors P and Q:

$$( \begin{matrix}S \\ R\end{matrix} ) = M ( \begin{matrix}P \\ Q\end{matrix} ) , \qquad ( 52 )$$

where, based on M defined as in equation of (49), S=P+jQ, and R=P−jQ respectively. Then, using relation equation (52), equation (45) is rewritten in terms of S and R:

$$( \begin{matrix}S ( z ) \\ R ( z )\end{matrix} ) = B ( \begin{matrix}S ( {z}_{0} ) \\ R ( {z}_{0} )\end{matrix} ) , \qquad ( 53 )$$

where B is the new two-way extrapolation operator we want to derive. Now, based on equations (46), (48), (49) and (50), B is obtained by a matrix-vector multiplication as follows:

$$B = M A {M}^{- 1} ( \begin{matrix}{R}_{c} ( L ) & {I}_{m} ( L ) \\ - {I}_{m} ( L ) & {R}_{c} ( L )\end{matrix} ) . \qquad ( 54 )$$

The matrix equations defined by equations (53) and (54) are equivalent to the two separate algebraic equations (41) and (42).

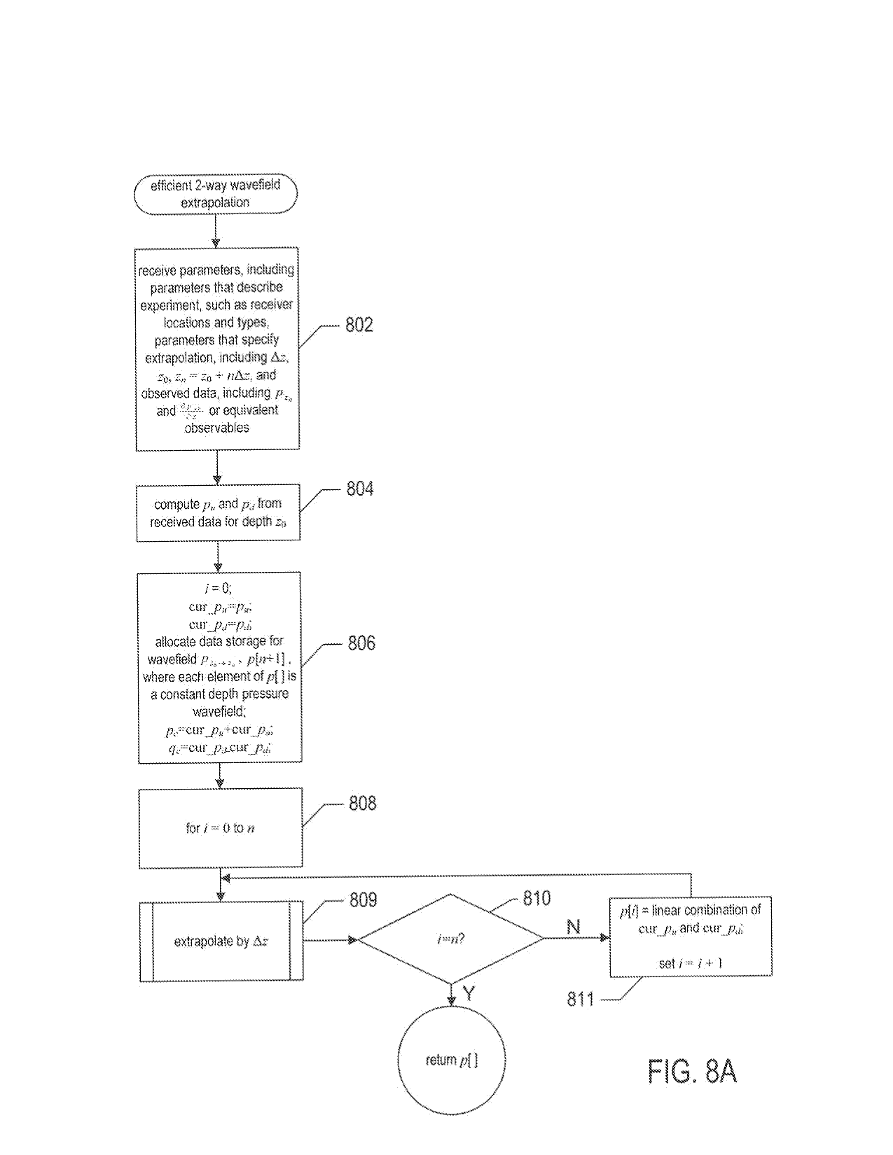

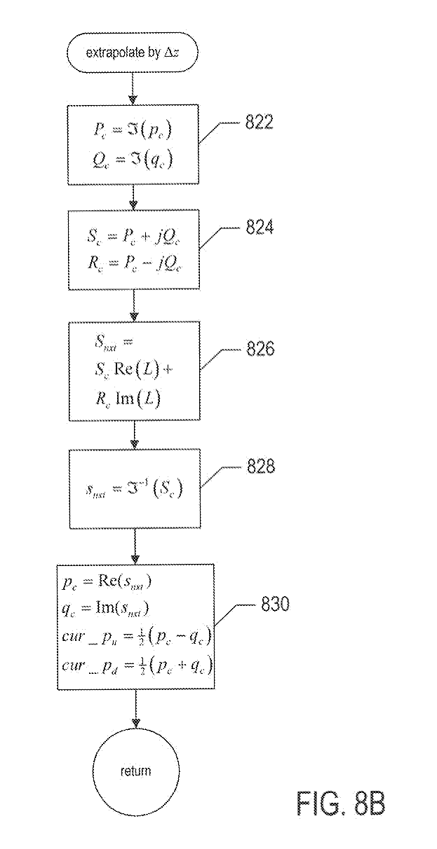

FIGS. 8A-B illustrate a wavefield-extrapolation method to which the present application is directed. As with the illustration of any computational processing method, the control-flow illustration provided in FIGS. 8A-B encompasses a number of particular different implementations. For the sake of clarity and brevity, various programming and implementation details are omitted, including the exact variables, control structures, and data structures employed. These programming and implementation details generally vary depending on the hardware platform, operating system, and programming-language choice, among other things. They may be associated with different performance and data-storage characteristics and thus represent different intentional balancings of many different trade-offs considered for different specific applications. Please note that the described computational processing method cannot possibly be carried out mentally or abstractly, but is instead necessarily a data-processing method executed within electronic computer systems that operate on various types of digitally encoded data stored within tangible, physical data-storage devices, including electronic memories, mass-storage devices, and other electro-mechanical and electro-optical mechanical data-storage devices.

While it should be well understood by anyone with even a cursory background in modern science and technology that computer-readable data-storage media and data-storage devices cannot possibly include electromagnetic waves, data-storage devices and data-storage media are defined to be tangible, physical entities, and not electromagnetic waves, that reliably store data, including computer instructions, observational data, input parameters, and other digitally encoded data, over periods of time and allow digitally encoded data stored by a computer system to be subsequently retrieved from the data-storage device or medium by the same or similar computer system.

It should also be noted that the computational processing method transforms data obtained from real-world exploration-seismology experiments into digitally encoded characterizations of subterranean features and material compositions that can be subsequently viewed, on display devices, or printed onto viewable media, for inspection and analysis by human users.

Finally, it should be noted that modern computer systems are generally general-purpose computational devices that only operate to produce useful results when controlled by a computer program. A computer program executed by a general-purpose computer system transforms the general-purpose computer system into a specialized computer system, controlled by the computer program, that carries out some well-defined task or set of tasks. Computer programs executed by a computer system are thus control components of special-purpose computer systems, as tangible, functional, and important as any other computer-system component.

In step 802 of FIG. 8A, the efficient two-way wavefield extrapolation method that is an example of the computational processing methods to which the current application is directed, receives various initial parameters, including parameters that describe the exploration-seismology experiment, the environmental context in which the method is carried out, including sensor locations and types, and various parameters that control operation of the method, such as the depth intervals for extrapolation Δz, and the number of extrapolations to carry out, n, and also receives the processed, observed data, including the z₀ wavefield p_{z}_{₀} and the derivative of z₀ wavefield with respect to depth, or other equivalent observed data.

Next, in step 804, the method computes the up-going and down-going wavefields, pᵤ and p_{d}, respectively, from the received, observed data for depth z₀. In step 806, the method prepares for an iterative extrapolation of a three-dimensional wavefield from a constant-depth sampling of the three-dimensional wavefield, such as the constant-depth sampling shown in FIG. 5A. Iteration variable i is set to 0, local variables cur_pᵤ and cur_p_{d} are set to pᵤ and p_{d}, respectively, and data storage space is allocated on one or more data-storage devices for the three-dimensional wavefield p_{z0→zn}, referred to in FIGS. 8A-B as “p[n+1]” or “p[ ],” where each element of p[n+1] is a constant-depth pressure wavefield. The real-valued wavefield fields p_{c}, q_{c} are generated from the current up-going and down-wing pressure wavefields, as discussed above with reference to equations (35) and (36). Next, in the for-loop of steps 808-811, the routine “extrapolate by Δz,” described below in FIG. 8B, is called in step 809 repeatedly to fully extrapolate the three-dimensional wavefield. For each iteration i, in step 811, a current constant-depth pressure wavefield is stored into p[i] and the iteration variable i is incremented. When the three-dimensional wavefield extrapolation is completed, as determined in step 810, the three-dimensional extrapolated wavefield stored in p[ ] is returned. It should be noted that any of many different types of control structures, in addition to a for-loop, can be used to implement the iterative extrapolation method discussed with reference to FIG. 8A. It should also be noted that iteration may proceed downward, as shown in this example, upward, and in other directions relevant to other dimensions with respect to which iteration may be carried out in alternative implementations. In the current example, iteration proceeds from a single constant-depth plane, but, under different experimental and data-collection methods, data for two or more constant-depth planes may be collected, and extrapolation may be carried out from each of the two or more constant-depth planes for respective adjacent portions of the experimental domain.

Please note, for the first iteration, that p[0] can be set to the pressure wavefield p_{z}_{₀}, received in step 802, rather than being calculated from cur_pᵤ and cur_p_{d}. Also, rather than the wavefield-extrapolation method allocating memory for p[ ], a routine or program that calls the wavefield-extrapolation method may instead allocate memory for p[ ], and pass a pointer to p[ ] as a parameter. The calling routine may, in alternative implementations, place the initial constant-depth wavefield into p[0] to avoid passing the initial constant-depth wavefield as a parameter.

FIG. 8B provides a control-flow diagram illustration of the routine “extrapolate by Δz,” called in step 809 of FIG. 8A. In step 822, scalar wavefields p_{c} and q_{c} are converted, by forward Fourier transform, to their wavenumber-angular-frequency domain counterparts P_{c} and Q_{c}, as also discussed above with reference to equations (37) and (38). Next, in step 824, complex wavefields S_{c} and R_{c} are generated from P_{c} and Q_{c}, as discussed above with reference to equations (39) and (40). Next, in step 826, S_{c} is extrapolated, by propagation, to Sₙₓₜ, the complex field S for a next-lower depth, using S_{c} and R_{c}, as discussed above with reference to equation (41). In step 828, the complex field sₙₓₜ is obtained by inverse Fourier transform of Sₙₓₜ, as discussed above with reference to equation (43). Finally, in step 830, the next-depth scalar fields p, and q, are extracted from the complex field sₙₓₜ, as discussed above, and the up-going and down-going wavefields for the next iteration, cur_pᵤ and cur_p_{d}, are obtained from p_{c} and q_{c}, as also discussed above.

The computational efficiency of the efficient two-way wavefield extrapolation computational processing method illustrated in FIGS. 8A-B is obtained, in part, by the fact that only one of the two complex fields S_{c} and R_{c} need be propagated in step 826. In the implementation illustrated in FIG. 8B, S_{c} is propagated while, in an alternative implementation, R_{c} may instead be propagated, according to equations (42) and (44). The scalar fields p and q can both be extracted from either complex virtual wavefield s or complex virtual wavefield r.

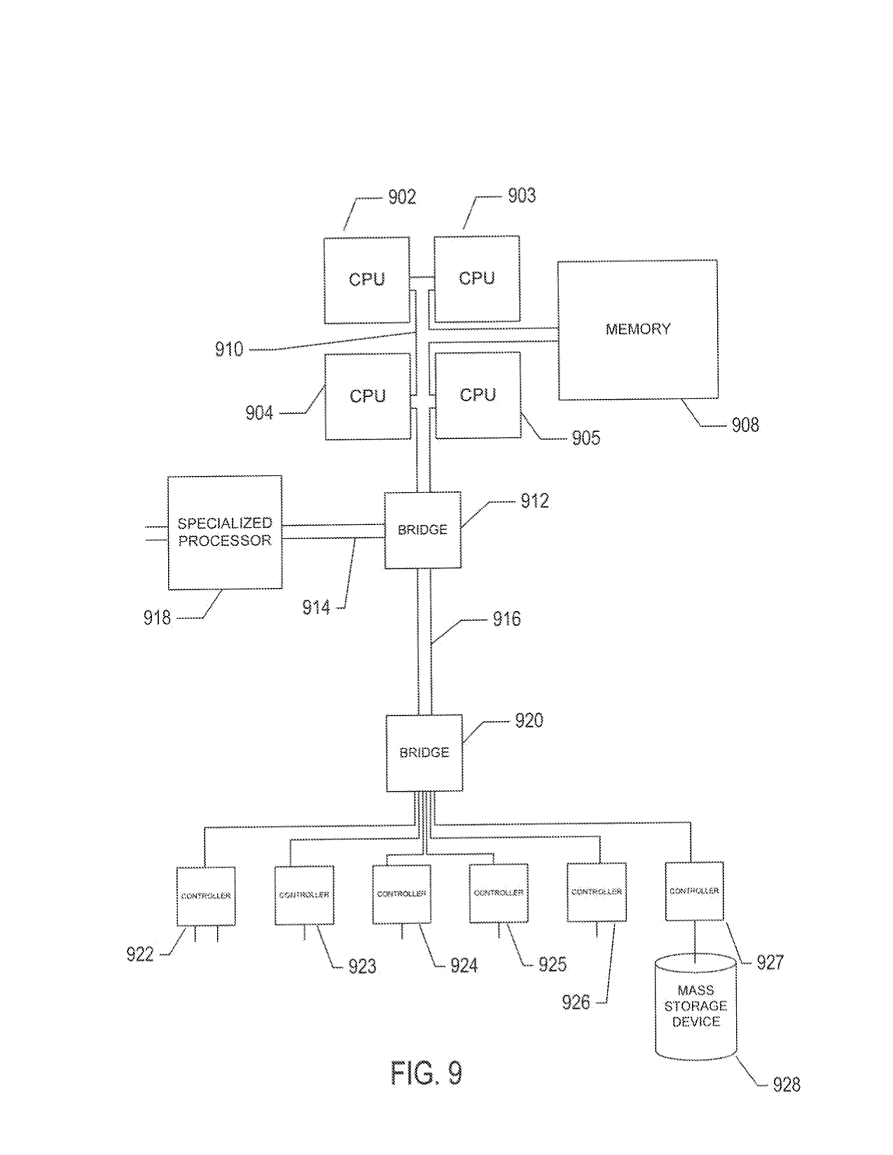

FIG. 9 shows one illustrative example of a generalized computer system that executes an efficient two-way wavefield extrapolation and therefore represents a seismic-analysis data-processing system to which the current application is directed. The internal components of many small, mid-sized, and large computer systems as well as specialized processor-based storage systems can be described with respect to this generalized architecture, although each particular system may feature many additional components, subsystems, and similar, parallel systems with architectures similar to this generalized architecture. The computer system contains one or multiple central processing units (“CPUs”) 902-905, one or more electronic memories 908 interconnected with the CPUs by a CPU/memory-subsystem bus 910 or multiple busses, a first bridge 912 that interconnects the CPU/memory-subsystem bus 910 with additional busses 914 and 916, or other types of high-speed interconnection media, including multiple, high-speed serial interconnects. These busses or serial interconnections, in turn, connect the CPUs and memory with specialized processors, such as a graphics processor 918, and with one or more additional bridges 920, which are interconnected with high-speed serial links or with multiple controllers 922-927, such as controller 927, that provide access to various different types of mass-storage devices 928, electronic displays, input devices, and other such components, subcomponents, and computational resources. The electronic displays, including visual display screen, audio speakers, and other output interfaces, and the input devices, including mice, keyboards, touchscreens, and other such input interfaces, together constitute input and output interfaces that allow the computer system to interact with human users. Computer-readable data-storage devices include various types of electronic memories, optical and magnetic disk drives, USB drives, and other such devices. Computer-readable data-storage media include optical disks, magnetic disks, and other media in which computer instructions and data can be encoded, during store operations, and from which encoded data can be retrieved, during read operations, by computer systems, data-storage systems, and peripheral devices.

Although the present invention has been described in terms of particular embodiments, it is not intended that the invention be limited to these embodiments. Modifications within the spirit of the invention will be apparent to those skilled in the art. For example, any number of different computational-processing-method implementations that carry out efficient two-way full-wavefield extrapolation based on virtual complex wavefields may be designed and developed using various different programming languages and computer platforms and by varying different implementation parameters, including control structures, variables, data structures, modular organization, and other such parameters. The computational representations of wavefields, operators, and other computational objects may be implemented in different ways. Although the efficient wavefield extrapolation method discussed above can be carried out on a single two-dimensional sampling to construct all extrapolated three-dimensional wavefield, wavefield extrapolation can be carried out using multiple two-dimensional samplings obtained experimentally for different depths, can be carried out from greater depths to shallower depths, and can be applied in many other contexts. Furthermore, as mentioned above, the extrapolation method discussed with reference to FIGS. 8A-B can be used for extrapolation along either of the x and)) spatial dimensions or the temporal dimension t. In addition, similar wavefield-extrapolation methods can be used for wavefields produced by P-waves and S-waves, as modeled by the elastic wave equation.

It is appreciated that the previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. An exploration-seismology computer system that extrapolates a first constant-depth wavefield for a first depth to a second constant-depth wavefield for a second depth, the exploration-seismology computer system comprising:
one or more processors;
one or more data-storage devices; and
an extrapolation routine, stored in one or more of the one or more data-storage devices that extrapolates the first constant-depth wavefield for the first depth to the second constant-depth wavefield for the second depth by computing two second-domain virtual complex-valued wavefields and propagating one of the two second-domain virtual complex-valued wavefields and that stores the second constant-depth wavefield for the second depth in one or more of the one or more data-storage devices.

2. The exploration-seismology computer system of claim 1 wherein the extrapolation routine extrapolates the first constant-depth wavefield for the first depth to the second constant-depth wavefield for the second depth by
transforming each of a first first-domain wavefield and second first-domain wavefield, generated from upgoing and downgoing wavefields corresponding to the first constant-depth wavefield, to corresponding first second-domain and second second-domain wavefields;
computing the two second-domain virtual complex-valued wavefields by combining the first second-domain wavefield and the second second-domain wavefield using two different operations;
propagating one of the two second-domain virtual complex-valued wavefields to the second depth and transforming the propagated second-domain virtual complex-valued wavefield to a corresponding first-domain virtual complex-valued wavefield for the second depth; and
extracting a first first-domain wavefield and second first-domain wavefield for the second depth from the first-domain virtual complex-valued wavefield, from which the second constant-depth wavefield for the second depth is generated.

3. The exploration-seismology computer system of claim 2 wherein the first first-domain wavefield and the second first-domain wavefield are generated from upgoing and downgoing wavefields corresponding to the first constant-depth wavefield by additive and subtractive linear combination, respectively.

4. The exploration-seismology computer system of claim 2 wherein transforming each of the first first-domain wavefield and the second first-domain wavefield, generated from upgoing and downgoing wavefields corresponding to the first constant-depth wavefield, to the corresponding first second-domain and second second-domain wavefields further comprises applying a discrete Fourier-transform computational operator to each of the first first-domain wavefield and the second first-domain wavefield.

5. The exploration-seismology computer system of claim 2 wherein computing the two second-domain virtual complex-valued wavefields by combining the first second-domain wavefield and the second second-domain wavefield using two different operations further comprises:
computing a first second-domain virtual complex-valued wavefield by additive linear combination of the first second-domain wavefield and the second second-domain wavefield; and
computing a second second-domain virtual complex-valued wavefield by subtractive linear combination of the first second-domain wavefield and the second second-domain wavefield.

6. The exploration-seismology computer system of claim 2 wherein propagating one of the two second-domain virtual complex-valued wavefields to the second depth further comprises additively combining a real portion of each complex value of a first one of the two second-domain virtual complex-valued wavefields with an imaginary portion of each complex value of a second one of the two second-domain virtual complex-valued wavefields.

7. The exploration-seismology computer system of claim 2 wherein transforming the propagated second-domain virtual complex-valued wavefield to a corresponding first-domain virtual complex-valued wavefield for the second depth further comprises applying a discrete inverse Fourier-transform computational operator to the propagated second-domain virtual complex-valued wavefield.

8. The exploration-seismology computer system of claim 2 wherein extracting a first first-domain wavefield and second first-domain wavefield for the second depth from the first-domain virtual complex-valued wavefield further comprises:
extracting real values for one of the first first-domain wavefield and second first-domain wavefield as the real parts of corresponding complex values of the first-domain virtual complex-valued wavefield; and
extracting real values for a second of the first first-domain wavefield and second first-domain wavefield as the real component of the imaginary parts of corresponding complex values of the first-domain virtual complex-valued wavefield.

9. The exploration-seismology computer system of claim 2 wherein the second constant-depth wavefield for the second depth is generated by linear combination of upgoing and downgoing wavefields for the second depth which are, in turn, generated by linear combination of the first first-domain wavefield and second first-domain wavefield.

10. A method, carried out by computer system that includes one or more processors and one or more data-storage devices and that that extrapolates a first constant-depth wavefield for a first depth to a second two-dimensional, constant-depth wavefield for a second depth, the method comprising:
extrapolating the first constant-depth wavefield for the first depth to the second constant-depth wavefield for the second depth by computing two second-domain virtual complex-valued wavefields and propagating one of the two second-domain virtual complex-valued wavefields; and
storing the second constant-depth wavefield for the second depth in one or more of the one or more data-storage devices.

11. The method of claim 10 wherein the extrapolation routine extrapolates the first constant-depth wavefield for the first depth to the second constant-depth wavefield for the second depth by
transforming each of a first first-domain wavefield and second first-domain wavefield, generated from upgoing and downgoing wavefields corresponding to the first two-dimensional, constant-depth wavefield, to corresponding first second-domain and second second-domain wavefields;
computing the two second-domain virtual complex-valued wavefields by combining the first second-domain wavefield and the second second-domain wavefield using two different operations;
propagating one of the two second-domain virtual complex-valued wavefields to the second depth and transforming the propagated second-domain virtual complex-valued wavefield to a corresponding first-domain virtual complex-valued wavefield for the second depth; and
extracting a first first-domain wavefield and second first-domain wavefield for the second depth from the first-domain virtual complex-valued wavefield, from which the second constant-depth wavefield for the second depth is generated.

12. The method of claim 11 wherein the first first-domain wavefield and the second first-domain wavefield are generated from upgoing and downgoing wavefields corresponding to the first constant-depth wavefield by additive and subtractive linear combination, respectively.

13. The method of claim 11 wherein transforming each of the first first-domain wavefield and the second first-domain wavefield, generated from upgoing and downgoing wavefields corresponding to the first constant-depth wavefield, to the corresponding first second-domain and second second-domain wavefields further comprises applying a discrete Fourier-transform computational operator to each of the first first-domain wavefield and the second first-domain wavefield.

14. The method of claim 11 wherein computing the two second-domain virtual complex-valued wavefields by combining the first second-domain wavefield and the second second-domain wavefield using two different operations further comprises:
computing a first second-domain virtual complex-valued wavefield by additive linear combination of the first second-domain wavefield and the second second-domain wavefield; and
computing a second second-domain virtual complex-valued wavefield by subtractive linear combination of the first second-domain wavefield and the second second-domain wavefield.

15. The method of claim 11 wherein propagating one of the two second-domain virtual complex-valued wavefields to the second depth further comprises additively combining a real portion of each complex value of a first one of the two second-domain virtual complex-valued wavefields with an imaginary portion of each complex value of a second one of the two second-domain virtual complex-valued wavefields.

16. The method of claim 11 wherein transforming the propagated second-domain virtual complex-valued wavefield to a corresponding first-domain virtual complex-valued wavefield for the second depth further comprises applying a discrete Fourier-transform computational operator to the propagated second-domain virtual complex-valued wavefield.

17. The method of claim 11 wherein extracting a first first-domain wavefield and second first-domain wavefield for the second depth from the first-domain virtual complex-valued wavefield further comprises:
extracting real values for one of the first first-domain wavefield and second first-domain wavefield as the real parts of corresponding complex values of the first-domain virtual complex-valued wavefield; and
extracting real values for a second of the first first-domain wavefield and second first-domain wavefield as the real component of the imaginary parts of corresponding complex values of the first-domain virtual complex-valued wavefield.

18. The method of claim 11 wherein the second constant-depth wavefield for the second depth is generated by linear combination of upgoing and downgoing wavefields for the second depth which are, in turn, generated by linear combination of the first first-domain wavefield and second first-domain wavefield.

19. The method of claim 10 encoded in computer instructions that are stored in one or more of a computer-readable data-storage device and a computer-readable data-storage medium.

20. An exploration-seismology computer system that extrapolates a three-dimensional pressure wavefield from at least one constant-depth wavefield, the exploration-seismology computer system comprising:
one or more processors;
one or more data-storage devices;
an extrapolation routine, stored in one or more of the one or more data-storage devices that extrapolates a first constant-depth wavefield for a first depth to a second constant-depth wavefield for a second depth by computing two second-domain virtual complex-valued wavefields and propagating one of the two second-domain virtual complex-valued wavefields and that stores the second constant-depth wavefield for the second depth in one or more of the one or more data-storage devices; and
an iterative routine, stored in one or more of the one or more data-storage devices, that invokes the extrapolation routine repeatedly to generate the three-dimensional pressure wavefield from the at least one constant-depth wavefield.
